(19) United States
(12) Patent Application Publication
(10) Pub. No.: US 2021/0127282 A1
(43) Pub. Date: Apr. 29, 2021

(54) RESOURCE USAGE MEASURING METHOD AND APPARATUS FOR PERFORMING THE SAME

(71) Applicant: ELECTRONICS AND TELECOMMUNICATIONS RESEARCH INSTITUTE, Daejeon (KR)

(72) Inventors: Jung Sun UM, Daejeon (KR); Seung Keun PARK, Daejeon (KR); Bong-Su KIM, Daejeon (KR); Igor KIM, Daejeon (KR)

(21) Appl. No.: 17/072,478

(22) Filed: Oct. 16, 2020

(30) Foreign Application Priority Data
Oct. 29, 2019 (KR) 10-2019-0135650
Oct. 29, 2019 (KR) 10-2019-0135667

(51) Int. Cl. H04W 24/08; H04L 5/00; H04W 72/12

(52) U.S. Cl. CPC H04W 24/08; H04W 72/12; H04L 5/0048

(57) ABSTRACT

A resource usage measuring method and an apparatus performing the same. The resource usage measuring method includes measuring a resource usage in a frequency domain based on a demodulation reference signal (DM-RS) transmitted from a base station, and measuring a resource usage in a time domain based on the DM-RS.

### CROSS-REFERENCE TO RELATED APPLICATION(S)

This application claims the priority benefit of Korean Patent Application No. 10-2019-0135650, filed on Oct. 29, 2019, and Korean Patent Application No. 10-2019-0135667, filed on Oct. 29, 2019, in the Korean Intellectual Property Office, the disclosures of which are incorporated herein by reference for all purposes.

### BACKGROUND

### 1. Field of the Invention

One or more example embodiments relate to a resource usage measuring method and an apparatus performing the same.

### 2. Description of Related Art

Since the commercialization of 4th generation (4G) communication systems, efforts have been made to develop a new 5th generation (5G) communication system to meet the increasing demand for wireless data traffic. The 5G communication system is referred to as a beyond 4G network communication system, a post LTE system, or a new radio (NR) system. In order to achieve a high data rate, it is considered to implement a 5G communication system in a base station and a terminal, including a system that operates using a super-high frequency (mmWave) band of 6 GHz or more and including a communication system that operates using a frequency band of 6 GHz or less in terms of securing coverage.

A 3rd generation partnership project (3GPP) NR system improves the spectral efficiency of a network, enabling telecommunications operators to provide more data and voice services in a given bandwidth. Therefore, the 3GPP NR system is designed to meet the demand for high-speed data and media transmission in addition to large-capacity voice support. The NR system has advantages of high throughput, low latency, frequency division duplex (FDD) and time division duplex (TDD) support, improved end-user environment, and low operating costs with a simple architecture on the same platform.

For more efficient data processing, dynamic TDD of the NR system may use a method of varying the number of orthogonal frequency division multiplexing (OFDM) symbols that are available for uplink and downlink according to the data traffic direction of users of a cell. For example, when the downlink traffic of the cell is more than the uplink traffic, a base station may allocate multiple downlink OFDM symbols to a slot (or subframe). Information on the slot configuration should be transmitted to terminals.

Various attempts are being made to apply the 5G communication system to an IoT network. For example, technologies for sensor networks, machine to machine (M2M), and machine type communication (MTC) are implemented by 5G communication techniques such as beamforming, multiple input multiple output (MIMO), array antennas, and the like. As the big data processing technology described above, IoT technology and 5G technology to which a cloud radio access network (cloud-RAN) is applied may be fused. In general, mobile communication systems have been developed to provide voice services while ensuring user activities.

However, the mobile communication systems are gradually expanding their range to not only voice services but also data services, and have developed to provide high-speed data services these days. However, the lack of resources in currently serviced mobile communication systems and user demands for high-speed services, a more advanced mobile communication system is needed.

In addition, to predict continuously increasing mobile data traffic and establish future frequency allocation plans in a circumstance in which services that utilize multi-band frequency aggregation technology through 5G communication systems and commercial services that combine mobile communication IoT services with various industries are provided, there is a demand for a method of measuring a frequency usage in a predetermined frequency band in which a 5D communication system is serviced.

### SUMMARY

An aspect provides technology for measuring a usage of resources used by a base station in a wireless communication system.

Another aspect provides technology for measuring a frequency resource being used by a terminal with high accuracy using energy detection (ED) in a wireless communication system.

According to an aspect, there is provided a resource usage measuring method including measuring a resource usage in a frequency domain based on a demodulation reference signal (DM-RS) transmitted from a base station, and measuring a resource usage in a time domain based on the DM-RS.

The measuring of the resource usage in the frequency domain may include detecting the number of resource blocks included in a resource block group allocated to physical downlink shared channel (PDSCH) scheduling, and verifying whether the DM-RS is transmitted in a symbol in which the DM-RS is likely to be transmitted in the unit of the resource block group.

The detecting may include determining a configuration of a bandwidth part (BWP) used by the base station, and detecting the number of resource blocks included in the resource block group based on the configuration of the BWP.

The verifying may include verifying whether the DM-RS is transmitted based on a correlation in the unit of the resource blocks.

The measuring of the resource usage in the frequency domain may include detecting an index of a first resource block allocated to the PDSCH scheduling and the number of consecutive resource blocks.

The measuring of the resource usage in the time domain may include detecting a DM-RS in a symbol, determining PDSCH scheduling allocation combinations based on an index of the symbol in which the DM-RS is detected, and determining a combination of symbols in which the DM-RS of the PDSCH is located among the combinations.

The detecting may include monitoring symbols in which the DM-RS of the PDSCH is likely to be located.

The determining may include determining the combination based on a reception power of the symbols.

The determining may include determining the combination based on a constellation of a signal transmitted in the symbols.

According to another aspect, there is provided a resource usage measuring apparatus including a memory configured to store instructions, and a processor configured to execute the instructions, wherein when the instructions are executed by the processor, the processor is configured to measure a resource usage in a frequency domain based on a DM-RS transmitted from a base station, and measure a resource usage in a time domain based on the DM-RS.

The processor may be configured to detect the number of resource blocks included in a resource block group allocated to PDSCH scheduling, and verify whether the DM-RS is transmitted in a symbol in which the DM-RS is likely to be transmitted in the unit of the resource block group.

The processor may be configured to determine a configuration of a BWP used by the base station, and detect the number of resource blocks included in the resource block group based on the configuration of the BWP.

The processor may be configured to verify whether the DM-RS is transmitted based on a correlation in the unit of the resource blocks.

The processor may be configured to detect an index of a first resource block allocated to the PDSCH scheduling and the number of consecutive resource blocks.

The processor may be configured to detect a DM-RS in a symbol, determine PDSCH scheduling allocation combinations based on an index of the symbol in which the DM-RS is detected, and determine a combination of symbols in which the DM-RS of the PDSCH is located among the combinations.

The processor may be configured to monitor symbols in which the DM-RS of the PDSCH is likely to be located.

The processor may be configured to determine the combination based on a reception power of the symbols.

The processor may be configured to determine the combination based on a constellation of a signal transmitted in the symbols

Additional aspects of example embodiments will be set forth in part in the description which follows and, in part, will be apparent from the description, or may be learned by practice of the disclosure.

### BRIEF DESCRIPTION OF THE DRAWINGS

These and/or other aspects, features, and advantages of the invention will become apparent and more readily appreciated from the following description of example embodiments, taken in conjunction with the accompanying drawings of which:

FIG. 1 illustrates an example of a radio frame structure used in a wireless communication system;

FIG. 2 illustrates an example of a structure of a resource grid of a 3rd generation partnership project new radio (3GPP NR) system;

FIG. 3 is a diagram to describe a physical channel used in a 3GPP system and an example of a general signal transmission method using the physical channel;

FIGS. 4A and 4B illustrate examples of SS/PBCH blocks for initial cell access in a 3GPP NR system;

FIG. 5A is a flowchart illustrating an example of a procedure for transmitting control information and a control channel in a 3GPP NR system, and FIG. 5B is a diagram to describe an example of transmitting control information and a control channel in the 3GPP NR system;

FIG. 6 illustrates an example of CORESET in which a PDCCH is to be transmitted in a 3GPP NR system;

FIG. 7 is a diagram illustrating an example of a method of setting a PDCCH search space in a 3GPP NR system;

FIG. 8 is a diagram to describe an example of carrier aggregation;

FIG. 9A is a diagram illustrating an example of a single-carrier subframe structure, and FIG. 9B is a diagram illustrating an example of a multi-carrier subframe structure;

FIG. 10 is a diagram illustrating an example of a method to which cross-carrier scheduling is applied;

FIG. 11 is a schematic block diagram illustrating a wireless communication system in which a resource usage measuring apparatus according to an example embodiment is implemented;

FIG. 12 is a schematic block diagram illustrating the resource usage measuring apparatus of FIG. 11;

FIG. 13 is a diagram to describe a resource usage measuring method performed by the resource usage measuring apparatus of FIG. 11;

FIG. 14 is a block diagram illustrating the wireless communication system of FIG. 11;

FIG. 15 is a schematic block diagram illustrating a wireless communication system in which a frequency resource measuring apparatus according to an example embodiment is implemented;

FIG. 16 is a schematic block diagram illustrating the frequency resource measuring apparatus of FIG. 15;

FIG. 17 is a diagram to describe a frequency resource measuring method performed by a frequency resource measuring apparatus according to an example embodiment; and

FIG. 18 is a block diagram illustrating the wireless communication system of FIG. 15.

### DETAILED DESCRIPTION

Hereinafter, example embodiments will be described in detail with reference to the accompanying drawings. However, various alterations and modifications may be made to the example embodiments. Here, the example embodiments are not construed as limited to the disclosure. The example embodiments should be understood to include all changes, equivalents, and replacements within the idea and the technical scope of the disclosure.

The terminology used herein is for the purpose of describing particular example embodiments only and is not to be limiting of the example embodiments. The singular forms “a”, “an”, and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof. Moreover, limitations such as “or more” or “or less” based on a specific threshold may be appropriately substituted with “above” or “more than” or “below” or “less than”, respectively.

Terms, such as first, second, and the like, may be used herein to describe components. Each of these terminologies is not used to define an essence, order or sequence of a corresponding component but used merely to distinguish the corresponding component from other component(s). For example, a first component may be referred to as a second component, and similarly the second component may also be referred to as the first component.

Unless otherwise defined, all terms including technical and scientific terms used herein have the same meaning as commonly understood by one of ordinary skill in the art to which example embodiments belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

When describing the example embodiments with reference to the accompanying drawings, like reference numerals refer to like constituent elements and a repeated description related thereto will be omitted. In the description of example embodiments, detailed description of well-known related structures or functions will be omitted when it is deemed that such description will cause ambiguous interpretation of the present disclosure.

Although terms used in the present specification are selected from general terminologies used currently and widely in consideration of functions, they may be changed in accordance with intentions of technicians engaged in the corresponding fields, customs, advents of new technologies and the like. In addition, in a specific case, most appropriate terms are arbitrarily selected by the applicant. In this instance, the meanings of the arbitrarily used terms will be clearly explained in the corresponding description. Hence, the terms should be understood not by the simple names of the terms but by the meanings of the terms and the following overall description of this specification.

The following example embodiments may apply to various wireless access systems such as a code division multiple access (CDMA) system, a frequency division multiple access (FDMA) system, a time division multiple access (TDMA) system, an orthogonal frequency division multiple access (OFDMA) system, a single carrier frequency division multiple access (SC-FDMA) system, and the like. CDMA may be implemented with radio technology such as Universal Terrestrial Radio Access (UTRA) or CDMA2000. TDMA may be implemented with wireless technology such as Global System for Mobile communications (GSM), General Packet Radio Service (GPRS), or Enhanced Data Rates for GSM Evolution (EDGE). OFDMA may be implemented with wireless technology such as IEEE 802.11 (Wi-Fi), IEEE 802.16 (WiMAX), IEEE 802-20, or Evolved UTRA (E-UTRA). UTRA may be a part of a universal mobile telecommunications system (UMTS). 3rd generation partnership project (3GPP) long term evolution (LTE) is a part of evolved UMTS (E-UMTS) that uses E-UTRA, and LTE-advanced (LTE-A) may be an evolved version of 3GPP LTE. 3GPP new radio (NR) is a system that is designed separately from LTE/LTE-A to support the requirements of IMT-2020, where the requirements are services for enhanced mobile broadband (eMBB), ultra-reliable and low latency communication (URLLC), and massive machine type communication (mMTC). Hereinafter, for a clear explanation, the description is provided based on 3GPP NR. However, the technical idea of the present disclosure is not limited thereto.

Unless otherwise specified in the specification, a base station may include a next generation node B (gNB) defined in 3GPP NR. In addition, unless otherwise specified, a terminal may include user equipment (UE). Hereinafter, for better understanding, the content of each example will be described as a separate example embodiment. However, example embodiments may be used in combination with each other. Hereinafter, configuring a terminal may refer to configuring a base station. Specifically, the base station may transmit a channel or signal to the terminal to set the operation of the terminal or the value of a parameter used in a wireless communication system.

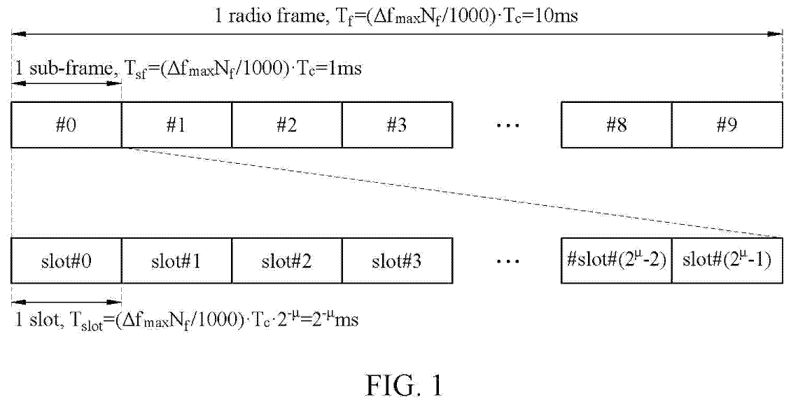

FIG. 1 illustrates an example of a radio frame structure used in a wireless communication system.

Referring to FIG. 1, a radio frame used in a 3GPP NR system may have a length of 10 milliseconds (ms) (ΔfₘₐₓN/100)·T_{c}). Further, the radio frame may include 10 subframes (SF) of equal size. Here, Δfₘₐₓ=480·103 Hz, N_{f}=4096, T_{c}=1/(Δf_{ref}·N_{f,ref}), Δfref=15*103 Hz, and N_{f,ref}=2048.

The 10 subframes in one radio frame may be numbered from 0 to 9. Each subframe may have a length of 1 ms and include one slot or a plurality of slots according to a subcarrier spacing.

Specifically, the 3GPP NR system may use a subcarrier spacing of 15·2^{μ} kHz. In this case, μ is a subcarrier spacing configuration and may have a value of 0 to 4. That is, the subcarrier spacing may be 15 kHz, 30 kHz, 60 kHz, 120 kHz, or 240 kHz.

A 1-ms long subframe may include 2μ slots. In this case, the length of each slot may be 2^{-μ}ms. Each of the 2^{μ} slots in one subframe may be numbered from 0 to 2^{μ}−1.

Each of the slots in one radio frame may be numbered from 0 to 10·2^{μ}−1. A time resource may be classified by at least one of a radio frame number (or radio frame index), a subframe number (or subframe index), and a slot number (or slot index).

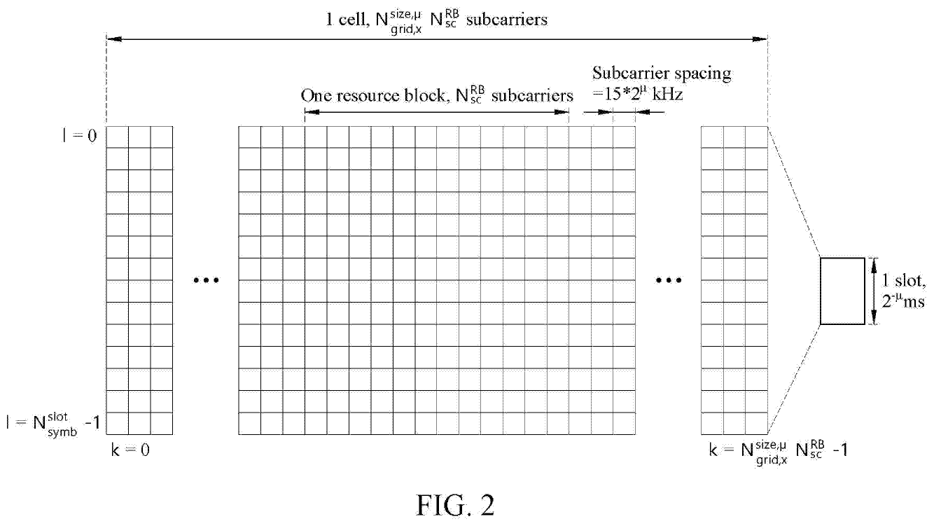

FIG. 2 illustrates an example of a structure of a resource grid of a 3GPP NR system.

In a wireless communication system, a downlink (DL) and/or uplink (UL) slot may include a resource grid having a structure as shown in FIG. 2.

There may be one resource grid per antenna port in the wireless communication system.

A slot may include a plurality of orthogonal frequency division multiplexing (OFDM) symbols in a time domain and a plurality of resource blocks (RBs) in a frequency domain. An OFDM symbol may be one symbol period. Unless otherwise specified, an OFDM symbol may be referred to as a symbol. One resource block may include 12 consecutive subcarriers in the frequency domain.

A signal transmitted in each slot may be represented by a resource grid including N_{grid,x}^{size,μ}N_{sc}^{RB} subcarriers and N_{symb}^{slot} OFDM symbols. Here, x=DL for a downlink resource grid, and x=UL for an uplink resource grid. N_{grid,x}^{size,μ} denotes the number of resource blocks according to the subcarrier spacing configuration μ, and N_{symb}^{slot} denotes the number of OFDM symbols in the slot. N_{sc}^{RB} denotes the number of subcarriers constituting one resource block, and N_{sc}^{RB}=12.

The OFDM symbol may be referred to as a cyclic prefix OFDM (CP-OFDM) symbol or a discrete Fourier transform spread OFDM (DFT-S-OFDM) symbol according to a multiple access scheme.

The number of OFDM symbols included in one slot may vary depending on the length of a cyclic prefix (CP). For example, in the case of a normal CP, one slot may include 14 OFDM symbols, and in the case of an extended CP, one slot may include 12 OFDM symbols. In a specific example embodiment, the extended CP may be used only in a 60 kHz subcarrier spacing.

In FIG. 2, for ease of description, an example of one slot including 14 OFDM symbols is illustrated. However, example embodiments may also be applied in the same manner to a slot including a different number of OFDM symbols.

Each OFDM symbol may include N_{grid,x}^{size,μ}N_{sc}^{RB} subcarriers in the frequency domain. The subcarriers may include a data subcarrier for data transmission, a reference signal subcarrier for reference signal transmission, and/or a guard band. A carrier frequency may also be referred to as a center frequency (f_{c}).

One resource block may be defined by N_{sc}^{RB} (for example, 12) consecutive subcarriers in the frequency domain. A resource including one OFDM symbol and one subcarrier may be referred to as a resource element (RE) or a tone. Thus, one resource block may include N_{grid,x}^{size,μ}N_{sc}^{RB} REs.

Each RE in a resource grid may be uniquely defined by an index pair (k, l) in one slot. k may be an index assigned from 0 to N_{grid,x}^{size,μ}N_{sc}^{RB}−1 in the frequency domain, and l may be an index assigned from 0 to N_{symb}^{slot}−1 in the time domain.

In order for a terminal to receive a signal from a base station or to transmit a signal to the base station, the time/frequency of the terminal may need to be synchronized with the time/frequency of the base station. When the base station and the terminal are synchronized, time and frequency parameters required for the terminal to perform demodulation of a DL signal and transmission of a UL signal at an accurate time may be determined.

Each symbol of a radio frame operating in time division duplex (TDD) or unpaired spectrum may be configured with at least one of a DL symbol, a UL symbol, or a flexible symbol.

A radio frame operating as a downlink carrier in a frequency division duplex (FDD) or paired spectrum may be configured with a DL symbol and/or a flexible symbol, and a radio frame operating as an uplink carrier may be configured with a UL symbol and/or a flexible symbol.

The DL symbol may enable downlink transmission and disable uplink transmission, whereas the UL symbol may enable uplink transmission and disable downlink transmission. The flexible symbol may be determined to be used for downlink or uplink according to a signal.

Information on the type of each symbol (for example, information regarding whether the symbol is a DL symbol, a UL symbol, or a flexible symbol) may be configured as a cell-specific or common radio resource control (RRC) signal.

In addition, the information on the type of each symbol may further be configured as a UE-specific or dedicated RRC signal.

The base station may use a cell-specific RRC signal to provide i) the period of cell-specific slot configuration, ii) the number of slots having only DL symbols from the beginning of the period of cell-specific slot configuration, iii) the number of DL symbols from the first symbol of a slot immediately following a slot having only DL symbols, iv) the number of slots having only UL symbols from the end of the period of cell-specific slot configuration, and v) the number of UL symbols from the last symbol of a slot immediately preceding a slot having only UL symbols. Here, a symbol configured as neither a UL symbol nor a DL symbol may be a flexible symbol.

When the information on the symbol type is configured as a UE-specific RRC signal, the base station may signal, with a cell-specific RRC signal, whether the flexible symbol is a DL symbol or a UL symbol. In this case, the UE-specific RRC signal may not change a DL symbol or UL symbol configured as a cell-specific RRC signal to another symbol type.

For each slot, the UE-specific RRC signal may signal the number of DL symbols and/or the number of UL symbols among N_{symb}^{slot} symbols of the slot. In this case, the DL symbols of the slot may be configured consecutively from a first symbol to an i^{th} symbol of the slot. Further, the UL symbols of the slot may be configured consecutively from a j^{th} symbol to a last symbol of the slot (here, i<j). In the slot, a symbol configured as neither a UL symbol nor a DL symbol may be a flexible symbol.

Information on the type of a symbol configured as an RRC signal as described above may be referred to as a semi-static DL/UL configuration. In the semi-static DL/UL configuration configured as an RRC signal, a flexible symbol may be indicated by a DL symbol, a UL symbol, and/or a flexible symbol through dynamic slot format information (SFI) transmitted through a physical downlink control channel (PDCCH). In this case, the DL symbol or UL symbol configured as an RRC signal is not changed to another symbol type. An example of the dynamic SFI that may be indicated by the base station to the terminal is shown in Table 1.

TABLE 1

| | Symbol number in a slot | | | | | | | | | | | | | |
|---|---|---|---|---|---|---|---|---|---|---|---|---|---|---|
| index | 0 | 1 | 2 | 3 | 4 | 5 | 6 | 7 | 8 | 9 | 10 | 11 | 12 | 13 |
| 0 | D | D | D | D | D | D | D | D | D | D | D | D | D | D |
| 1 | U | U | U | U | U | U | U | U | U | U | U | U | U | U |
| 2 | X | X | X | X | X | X | X | X | X | X | X | X | X | X |
| 3 | D | D | D | D | D | D | D | D | D | D | D | D | D | X |
| 4 | D | D | D | D | D | D | D | D | D | D | D | D | X | X |
| 5 | D | D | D | D | D | D | D | D | D | D | D | X | X | X |
| 6 | D | D | D | D | D | D | D | D | D | D | X | X | X | X |
| 7 | D | D | D | D | D | D | D | D | D | X | X | X | X | X |
| 8 | X | X | X | X | X | X | X | X | X | X | X | X | X | U |
| 9 | X | X | X | X | X | X | X | X | X | X | X | X | U | U |
| 10 | X | U | U | U | U | U | U | U | U | U | U | U | U | U |
| 11 | X | X | U | U | U | U | U | U | U | U | U | U | U | U |
| 12 | X | X | X | U | U | U | U | U | U | U | U | U | U | U |
| 13 | X | X | X | X | U | U | U | U | U | U | U | U | U | U |
| 14 | X | X | X | X | X | U | U | U | U | U | U | U | U | U |
| 15 | X | X | X | X | X | X | U | U | U | U | U | U | U | U |
| 16 | D | X | X | X | X | X | X | X | X | X | X | X | X | X |
| 17 | D | D | X | X | X | X | X | X | X | X | X | X | X | X |
| 18 | D | D | D | X | X | X | X | X | X | X | X | X | X | X |
| 19 | D | X | X | X | X | X | X | X | X | X | X | X | X | U |
| 20 | D | D | X | X | X | X | X | X | X | X | X | X | X | U |
| 21 | D | D | D | X | X | X | X | X | X | X | X | X | X | U |
| 22 | D | X | X | X | X | X | X | X | X | X | X | X | U | U |
| 23 | D | D | X | X | X | X | X | X | X | X | X | X | U | U |
| 24 | D | D | D | X | X | X | X | X | X | X | X | X | U | U |
| 25 | D | X | X | X | X | X | X | X | X | X | X | U | U | U |
| 26 | D | D | X | X | X | X | X | X | X | X | X | U | U | U |
| 27 | D | D | D | X | X | X | X | X | X | X | X | U | U | U |
| 28 | D | D | D | D | D | D | D | D | D | D | D | D | X | U |
| 29 | D | D | D | D | D | D | D | D | D | D | D | X | X | U |
| 30 | D | D | D | D | D | D | D | D | D | D | X | X | X | U |
| 31 | D | D | D | D | D | D | D | D | D | D | D | X | U | U |
| 32 | D | D | D | D | D | D | D | D | D | D | X | X | U | U |
| 33 | D | D | D | D | D | D | D | D | D | X | X | X | U | U |
| 34 | D | X | U | U | U | U | U | U | U | U | U | U | U | U |
| 35 | D | D | X | U | U | U | U | U | U | U | U | U | U | U |
| 36 | D | D | D | X | U | U | U | U | U | U | U | U | U | U |
| 37 | D | X | X | U | U | U | U | U | U | U | U | U | U | U |
| 38 | D | D | X | X | U | U | U | U | U | U | U | U | U | U |
| 39 | D | D | D | X | X | U | U | U | U | U | U | U | U | U |
| 40 | D | X | X | X | U | U | U | U | U | U | U | U | U | U |
| 41 | D | D | X | X | X | U | U | U | U | U | U | U | U | U |
| 42 | D | D | D | X | X | X | U | U | U | U | U | U | U | U |
| 43 | D | D | D | D | D | D | D | D | D | X | X | X | X | U |
| 44 | D | D | D | D | D | D | X | X | X | X | X | X | U | U |
| 45 | D | D | D | D | D | D | X | X | U | U | U | U | U | U |
| 46 | D | D | D | D | D | X | U | D | D | D | D | D | X | U |
| 47 | D | D | X | U | U | U | U | D | D | X | U | U | U | U |
| 48 | D | X | U | U | U | U | U | D | X | U | U | U | U | U |
| 49 | D | D | D | D | X | X | U | D | D | D | D | X | X | U |
| 50 | D | D | X | X | U | U | U | D | D | X | X | U | U | U |
| 51 | D | X | X | U | U | U | U | D | X | X | U | U | U | U |
| 52 | D | X | X | X | X | X | U | D | X | X | X | X | X | U |
| 53 | D | D | X | X | X | X | U | D | D | X | X | X | X | U |
| 54 | X | X | X | X | X | X | X | D | D | D | D | D | D | D |
| 55 | D | D | X | X | X | U | U | U | D | D | D | D | D | D |

| | |
|---|---|
| 56~255 | Reserved |

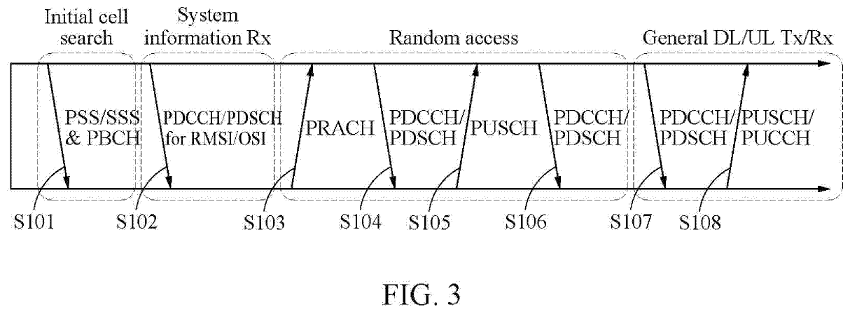

In Table 1, D denotes a DL symbol, U denotes a UL symbol, and X denotes a flexible symbol. DL/UL switching may be allowed up to two times in one slot. FIG. 3 is a diagram to describe a physical channel used in a 3GPP system and an example of a general signal transmission method using the physical channel.

A 3GPP system may be, for example, an NR system.

A terminal is powered on or newly enters a cell, the terminal may perform an initial cell search, in operation S101. Specifically, the terminal may be synchronized with abase station in the initial cell search. To achieve this, the terminal may receive a primary synchronization signal (PSS) and a secondary synchronization signal (SSS) from the base station to be synchronized with the base station, and obtain information such as cell ID. Thereafter, the terminal may receive a physical broadcast channel from the base station to obtain broadcast information in the cell.

Upon completion of the initial cell search, the terminal may obtain more specific system information than the system information obtained through the initial cell search, by receiving a physical downlink control channel (PDCCH) and a physical downlink shared channel (PDSCH) according to information carried on the PDCCH, in operation S102. Here, the system information received by the terminal may be cell-common system information used for the terminal to properly operate in a physical layer of RRC, and may also be referred to as remaining system information or system information block (SIB).

If the terminal accesses the base station for the first time or does not have radio resources for signal transmission (for example, if the terminal is in an RRC_IDLE mode), the terminal may perform random access to the base station, in operations S103 to S106.

In operation S103, the terminal may transmit a preamble through a physical random access channel (PRACH). In operation S104, the terminal may receive a response message to the preamble from the base station through a PDCCH and a corresponding PDSCH.

When the terminal receives a valid random access response message, the terminal may transmit data including its own identifier, and the like to the base station through a physical uplink shared channel (PUSCH) indicated by an uplink grant transmitted from the base station through the PDCCH, in operation S105. Next, the terminal may wait for the reception of the PDCCH as an indication of the base station for collision resolution, and when the terminal successfully receives the PDCCH through its identifier in operation S106, the random access process may be terminated.

During the random access process, the terminal may obtain UE-specific system information necessary for the terminal to properly operate at a physical layer in the RRC layer. When the terminal obtains terminal-specific system information from the RRC layer, the terminal may enter an RRC connection mode (RRC_CONNECTED mode).

The RRC layer may be used for generating and managing messages for control between the terminal and a radio access network (RAN). For example, the base station and the terminal may perform storage management including broadcasting of cell system information that is necessary for all terminals in a cell at the RRC layer, paging message delivery management, mobility management and handover, terminal measurement report and control therefor, terminal capability management and/or security management (for example, key management).

In general, an update of a signal transmitted at the RRC layer (hereinafter, the RRC signal) is longer than a transmission time interval (TTI) in the physical layer, and thus, the RRC signal may be maintained unchanged for a long time interval.

As a general uplink/downlink signal transmission procedure after the operations S101 to S106 described above, the terminal may receive PDCCH/PDSCH in operation S107, and transmit physical uplink shared channel (PUSCH)/physical uplink control channel (PUCCH) in operation S108.

The terminal may receive downlink control information (DCI) through the PDCCH. The DCI may include control information such as resource allocation information for the terminal.

The format of the DCI may vary depending on the purpose of use. The uplink control information (UCI) transmitted by the terminal to the base station through the uplink may include a downlink/uplink ACK/NACK signal, a channel quality indicator (CQI), a precoding matrix index (PMI), a rank indicator (RI), and the like. Here, the CQI, the PMI, and the RI may be included in channel state information (CSI).

In the case of a 3GPP NR system, the terminal may transmit the control information such as HARQ-ACK, CSI, and the like described above through PUSCH and/or PUCCH.

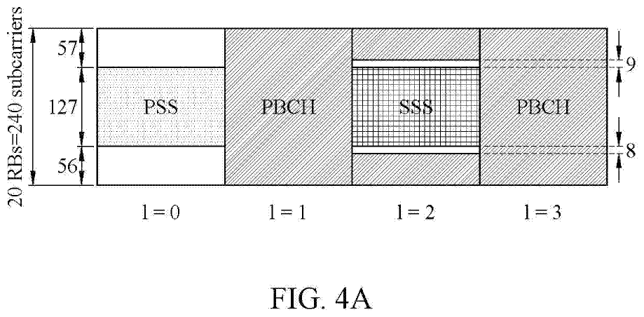

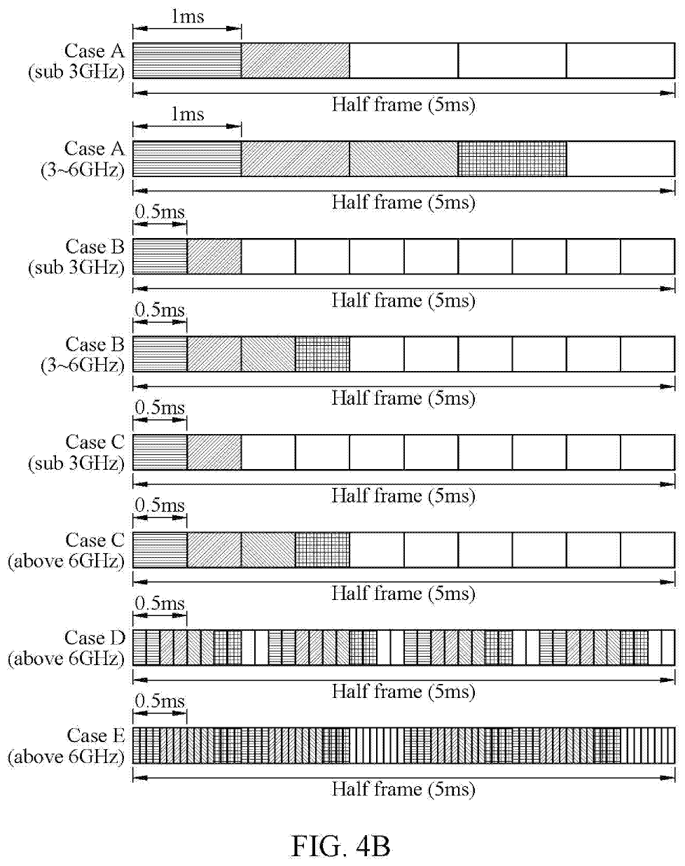

FIGS. 4A and 4B illustrate examples of SS/PBCH blocks for initial cell access in a 3GPP NR system.

When a terminal is powered on or attempts to newly access a cell, the terminal may acquire time and frequency synchronization with the cell and perform an initial cell search process. The terminal may detect a physical cell identity N^{cell}_{ID} of the cell in the cell search process.

The terminal may receive a synchronization signal from a base station and be synchronized with the base station. In this case, the terminal may obtain information such as the cell identity (ID).

The synchronization signal SS may be divided into a primary synchronization signal (PSS) and a secondary synchronization signal (SSS).

The PSS may be used to obtain time domain synchronization and/or frequency domain synchronization such as OFDM symbol synchronization and slot synchronization. The SSS may be used to obtain frame synchronization and cell group ID.

Referring to FIG. 4A and Table 2, an SS/PBCH block may include 20 RBs (for example, 240 subcarriers) that are consecutive along a frequency axis, and 4 OFDM symbols that are consecutive along a time axis.

In this case, in the SS/PBCH block, the PSS may be transmitted through the first OFDM symbol, and the SSS may be transmitted through the 56^{th} to 182^{nd} subcarriers in the third OFDM symbol. Here, the lowest subcarrier index of the SS/PBCH block may be assigned from 0.

In the first OFDM symbol in which the PSS is transmitted, the base station may not transmit the signal through the remaining subcarriers, that is, the 0^{th} to 55^{th} and 183^{rd} to 239^{th} subcarriers. In addition, in the third OFDM symbol in which the SSS is transmitted, the base station may not transmit the signal through the 48^{th} to 55^{th} and 183^{rd} to 191^{st} subcarriers.

The base station may transmit a physical broadcast channel (PBCH) through the remaining REs except for the above signal in the SS/PBCH block.

TABLE 2

| | OFDM symbol number l | Subcarrier number k |
|---|---|---|
| Channel | relative to the start | relative to the start of |
| or signal | of an SS/PBCH block | an SS/PBCH block |
| PSS | 0 | 56, 57, . . . , 182 |
| SSS | 2 | 56, 57, . . . , 182 |
| Set to 0 | 0 | 0, 1, . . . , 55, 183, 184, . . . , 239 |
| | 2 | 48, 49, . . . , 55, 183, 184, . . . , 191 |
| PBCH | 1, 3 | 0, 1, . . . , 239 |
| | 2 | 0, 1, . . . , 47, |
| | | 192, 193, . . . , 239 |
| DM-RS for | 1, 3 | 0 + v,4 + v,8 + v, . . . , 236 + v |
| PBCH | 2 | 0 + v,4 + v,8 + v, . . . , 44 + v |
| | | 192 + v,196 + v, . . . , 236 + v |

The SSs may be grouped into 336 physical-layer cell-identifier groups each including 3 unique identifiers such that each of a total of 1008 unique physical layer cell identifier becomes a part of only one physical-layer cell-identifier group through three combinations of the PSS and the SSS.

Therefore, the physical layer cell ID N^{cell}_{ID}=3N⁽¹⁾_{ID}+N⁽²⁾_{ID} may be uniquely defined by an index N⁽¹⁾_{ID} in the range of 0 to 335 indicating a physical-layer cell-identifier group and an index N⁽²⁾_{ID} from 0 to 2 indicating the physical-layer identifier in the physical-layer cell-identifier group.

The terminal may detect the PSS and identify one of the three unique physical-layer identifiers. In addition, the terminal may detect the SSS and identify one of the 336 physical layer cell IDs associated with the physical-layer identifier.

In this case, the sequence d_{PSS}(n) of the PSS may be expressed by Equation 1.

d_{PSS}(n)=1−2x(m)

m=(n+43N_{ID}⁽²⁾) mod127

0≤n<127 [Equation 1]

Here, x(i+7)=(x(i+4)+x(i))mod2, and [x(6) x(5) x(4) x(3) x(2) x(1) x(0)]=[1 1 1 0 1 1 0].

In addition, the sequence d_{SSS}(n) of the SSS may be expressed by Equation 2.

$$\begin{matrix}{d}_{S S S} ( n ) = [ 1 - 2 {x}_{0} ( ( n + {m}_{0} ) mod 127 ) ] [ 1 - 2 {x}_{1} ( ( n + {m}_{1} ) mod 127 ) ] \\ {m}_{0} = 15 ⌊ \frac{{N}_{I D}^{( 1 )}}{112} ⌋ + 5 {N}_{ID}^{( 2 )} \\ {m}_{1} = {N}_{ID}^{( 1 )} mod 112 \\ 0 \leq n < 127 & [ Equation 2 ] \\ Here , {x}_{0} ( i + 7 ) = ( {x}_{0} ( i + 4 ) + {x}_{0} ( i ) ) mod 2 \\ {x}_{1} ( i + 7 ) = ( {x}_{1} ( i + 1 ) + {x}_{1} ( i ) ) mod 2 , and \\ [ \begin{matrix}{x}_{0} ( 6 ) & {x}_{0} ( 5 ) & {x}_{0} ( 4 ) & {x}_{0} ( 3 ) & {x}_{0} ( 2 ) & {x}_{0} ( 1 ) & {x}_{0} ( 0 )\end{matrix} ] = [ \begin{matrix}0 & 0 & 0 & 0 & 0 & 0 & 1\end{matrix} ] \\ [ \begin{matrix}{x}_{1} ( 6 ) & {x}_{1} ( 5 ) & {x}_{1} ( 4 ) & {x}_{1} ( 3 ) & {x}_{1} ( 2 ) & {x}_{1} ( 1 ) & {x}_{1} ( 0 )\end{matrix} ] = [ \begin{matrix}0 & 0 & 0 & 0 & 0 & 0 & 1\end{matrix} ] . & \end{matrix}$$

A 10-ms long radio frame may be divided into two 5-ms long half frames. FIG. 4B illustrates slots in which an SS/PBCH block is transmitted within a half frame.

A slot in which an SS/PBCH block is transmitted may be in any one of Cases A, B, C, D, and E.

In Case A, the subcarrier spacing may be 15 kHz, and the start point of the SS/PBCH block may be a {2, 8}+14·n^{th} symbol. In this case, n may be 0 or 1 at a carrier frequency of 3 GHz or less. In addition, n may be 0, 1, 2, or 3 at a carrier frequency of more than 3 GHz and less than or equal to 6 GHz.

In Case B, the subcarrier spacing may be 30 kHz, and the start point of the SS/PBCH block may be a {4, 8, 16, 20}+28·n^{th} symbol. In this case, n may be 0 at a carrier frequency of 3 GHz or less. In addition, n may be 0 or 1 at a carrier frequency of more than 3 GHz and less than or equal to 6 GHz.

In Case C, the subcarrier spacing may be 30 kHz, and the start point of the SS/PBCH block may be a {2, 8}+14·n^{th} symbol. In this case, n may be 0 or 1 at a carrier frequency of 3 GHz or less. In addition, n may be 0, 1, 2, or 3 at a carrier frequency of more than 3 GHz and less than or equal to 6 GHz.

In Case D, the subcarrier spacing may be 120 kHz, and the start point of the SS/PBCH block may be a {4, 8, 16, 20}+28·n^{th} symbol. In this case, n may be 0, 1, 2, 3, 5, 6, 7, 8, 10, 11, 12, 13, 15, 16, 17, or 18 at a carrier frequency of 6 GHz or more.

In Case E, the subcarrier spacing may be 240 kHz, and the start point of the SS/PBCH block may be a {8, 12, 16, 20, 32, 36, 40, 44}+56·n^{th} symbol. In this case, n may be 0, 1, 2, 3, 5, 6, 7, or 8 at a carrier frequency of 6 GHz or more.

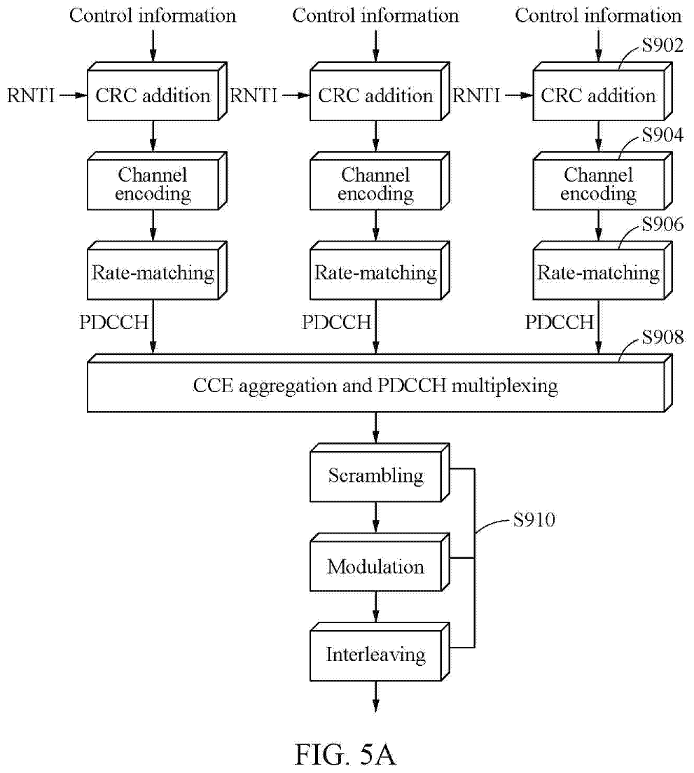

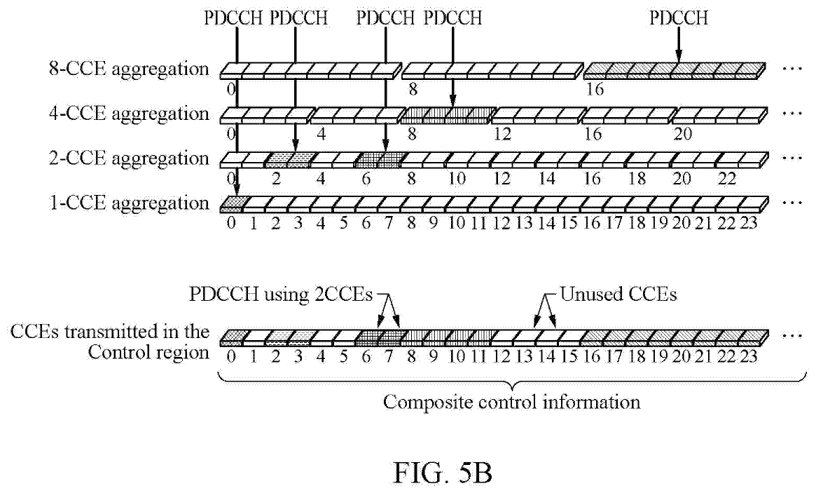

FIG. 5A is a flowchart illustrating an example of a procedure for transmitting control information and a control channel in a 3GPP NR system, and FIG. 5B is a diagram to describe an example of transmitting control information and a control channel in the 3GPP NR system.

In operation S902, a base station may add a cyclic redundancy check (CRC) masked (for example, XORed) with a radio network temporary identifier (RNTI) to control information (for example, DCI). The base station may scramble the CRC with an RNTI value determined according to the purpose/target of each control information.

A common RNTI used by one or more terminals may include at least one of a system information RNTI (SI-RNTI), a paging RNTI (P-RNTI), a random access RNTI (RA-RNTI), and a transmit power control RNTI (TPC-RNTI). In addition, a UE-specific RNTI may include at least one of a cell temporary RNTI (C-RNTI) and a CS-RNTI.

In operation S906, the base station may perform rate-matching according to an amount of resources used for PDCCH transmission after performing channel encoding (for example, polar coding) in operation S904.

In operation S908, the base station may multiplex the DCI based on the control channel element (CCE)-based PDCCH structure. Further, the base station may apply an additional process such as scrambling, modulation (for example, QPSK), and interleaving to the multiplexed DCI in operation S910, and then map the processed DCI to a resource to be transmitted.

A CCE is a basic resource unit for PDCCH, and one CCE may include a plurality of (for example, 6) resource element groups (REGs). One REG may include a plurality of (for example, 12) REs.

The number of CCEs used for one PDCCH may be defined as an aggregation level. In a 3GPP NR system, an aggregation level of 1, 2, 4, 8, or 16 may be used.

FIG. 5B is a diagram illustrating CCE aggregation levels and PDCCH multiplexing, and shows the types of CCE aggregation levels used for one PDCCH and CCE(s) transmitted in a control region according thereto.

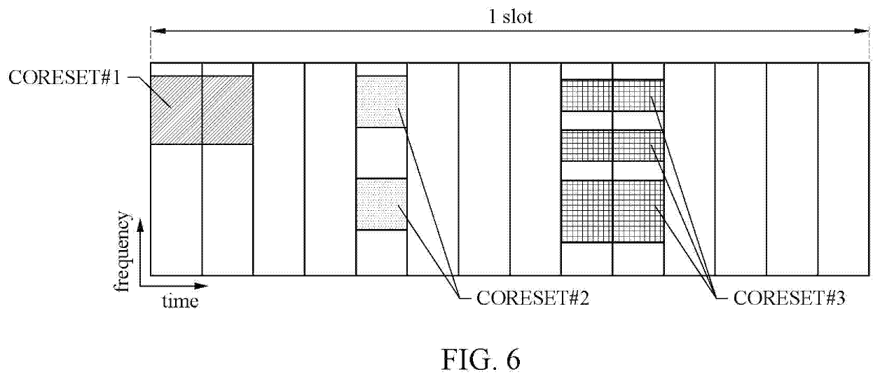

FIG. 6 illustrates an example of CORESET in which a PDCCH is to be transmitted in a 3GPP NR system.

A control resource set CORESET may be a time-frequency resource in which PDCCH, a control signal for a terminal, is transmitted. A search space, which will be described later, may be mapped to one CORESET. Accordingly, the terminal may decode the PDCCH mapped to the CORESET by monitoring the time-frequency domain designated for the CORESET, rather than monitoring all frequency bands for PDCCH reception.

The base station may configure one CORESET or a plurality of CORESETs for each cell to the terminal. The CORESET may include up to 3 consecutive symbols along a time axis. In addition, the CORESET may include six consecutive physical resource blocks (PRBs) along a frequency axis.

CORESET #1 includes consecutive PRBs, and CORESET #2 and CORESET #3 include inconsecutive PRBs. The CORESET may be placed in any symbol in the slot. For example, CORESET #1 may start at the first symbol of the slot, CORESET #2 may start at the 5^{th} symbol of the slot, and CORESET #9 may start at the 9^{th} symbol of the slot.

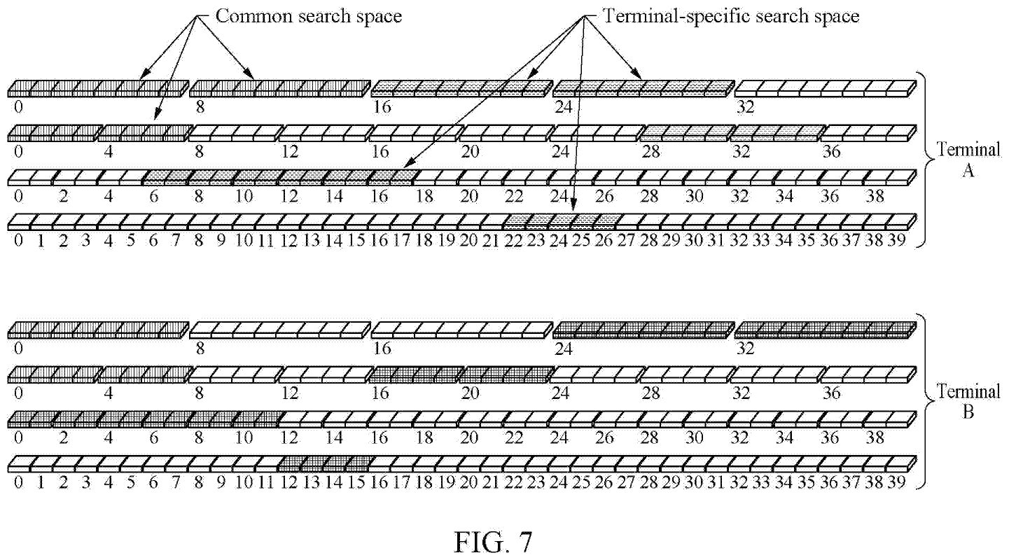

FIG. 7 is a diagram illustrating an example of a method of setting a PDCCH search space in a 3GPP NR system.

To transmit a PDCCH to a terminal, at least one search space may exist in each CORESET. The search space is a set of all time-frequency resources (hereinafter, PDCCH candidates) in which the PDCCH of the terminal may be transmitted.

The search space may include a common search space to be searched commonly by terminals of 3GPP NR and a terminal-specific search space or UE-specific search space to be searched by a specific terminal.

In the common search space, a PDCCH set to be searched for commonly by all terminals in cells belonging to the same base station may be monitored. In addition, the terminal-specific search space may be set for each terminal so that PDCCHs respectively allocated to terminals may be monitored at different search space positions of the terminals.

The terminal-specific search space may be allocated to partially overlap another terminal-specific search space due to a limited control region in which a PDCCH may be allocated. Monitoring the PDCCH may include blind decoding PDCCH candidates in a search space.

Success in blind decoding may be expressed as a PDCCH is (successfully) detected/received, and failure in blind decoding may be expressed as a PDCCH is not detected/not received, or is not successfully detected/received.

Hereinafter, for ease of description, a PDCCH scrambled with a group common (GC) RNTI already known by one or more terminals in order to transmit downlink control information to the one or more terminals will be referred to as a group common PDCCH or a common PDCCH.

In addition, a PDCCH scrambled with a UE-specific RNTI already known by a specific terminal in order to transmit uplink scheduling information or downlink scheduling information to the specific terminal will be referred to as a UE-specific PDCCH.

The common PDCCH may be included in the common search space, and the UE-specific PDCCH may be included in the common search space and/or the UE-specific PDCCH.

The base station may inform, through the PDCCH, each terminal or terminal group of information (for example, DL Grant) related to resource allocation of transmission channels such as a paging channel (PCH) and a downlink-shared channel (DL-SCH), or of information (for example, UL Grant) related to a hybrid automatic repeat request (HARQ) and resource allocation of an uplink-shared channel (UL-SCH).

The base station may transmit a PCH transport block and a DL-SCH transport block through the PDSCH. The base station may transmit data excluding specific control information or specific service data through the PDSCH. In addition, the terminal may receive data excluding specific control information or specific service data through the PDSCH.

The base station may transmit a PDCCH containing information on which terminal (one or more terminals) PDSCH data is transmitted to and how the corresponding terminal should receive and decode the PDSCH data.

For example, assuming that DCI transmitted through a specific PDCCH is CRC-masked with an RNTI of “A” and that the DCI indicates a PDSCH is allocated to a radio resource (for example, frequency location) of “B” and indicates transmission format information (for example, the transport block size, modulation scheme, coding information, etc.) of “C”, the terminal monitors the PDCCH using RNTI information that the terminal has. In this case, if there is a terminal that performs blind decoding of the PDCCH using the RNTI of “A”, the terminal may receive the PDCCH and receive the PDSCH indicated by “B” and “C” through the information in the received PDCCH.

Table 3 shows an example of a PUCCH used in a wireless communication system.

TABLE 3

| PUCCH format | Length in OFDM symbols | Number of bits |
|---|---|---|
| 0 | 1-2 | ≤2 |
| 1 | 4-14 | ≤2 |
| 2 | 1-2 | >2 |
| 3 | 4-14 | >2 |
| 4 | 4-14 | >2 |

A PUCCH may be used to transmit uplink control information (UCI). The UCI may include a scheduling request (SR), a HARQ-ACK, and/or channel state information (CSI).

The SR may be information used to request an uplink UL-SCH resource.

The HARQ-ACK may be a response to a PDCCH (indicating a DL SPS release) and/or a response to a downlink transport block (TB) on the PDSCH. The HARQ-ACK may indicate whether information transmitted through the PDCCH or PDSCH is successfully received. A HARQ-ACK response may include a positive ACK (hereinafter, ACK), a negative ACK (hereinafter, NACK), a discontinuous transmission (DTX), and/or NACK/DTX. The HARQ-ACK may be referred to interchangeably as HARQ-ACK/NACK and/or ACK/NACK. An ACK may be expressed as a bit value of 1, and a NACK may be expressed as a bit value of 0.

The CSI may be feedback information on a downlink channel. The terminal may generate the CSI based on a CSI-reference signal (CSI-RS) transmitted by the base station. Feedback information related to multiple input multiple output (MIMO) may include a rank indicator (RI) and a precoding matrix indicator (PMI). The CSI may be divided into CSI Part 1 and CSI Part 2 depending on the information indicated by the CSI.

In a 3GPP NR system, five PUCCH formats may be used to support various service scenarios and various channel environments and frame structures.

PUCCH format 0 may be a format to transmit 1-bit or 2-bit HARQ-ACK information or SR.

PUCCH format 0 may be transmitted through one or two OFDM symbols on the time axis and one PRB on the frequency axis. When PUCCH format 0 is transmitted through two OFDM symbols, the same sequence may be transmitted in different RBs through the two symbols. In this case, the sequence may be a sequence that is cyclically shifted from a base sequence used in PUCCH format 0. Through this, the terminal may obtain a frequency diversity gain.

In detail, the terminal may determine a cyclic shift (CS) value m_{cs} according to M_{bit}-bit UCI (1 or 2). In addition, a sequence that is cyclically shifted from the base sequence with a length of 12 based on the determined CS value m_{cs} may be mapped to 1 OFDM symbol and 12 REs of 1 RB and transmitted.

When the number of cyclic shifts available to the terminal is 12 and M_{bit}=1, 1-bit UCI 0 and 1 may be respectively mapped to two cyclically shifted sequences having a difference of 6 in cyclic shift values. In addition, when M_{bit}=2, 2-bit UCI 00, 01, 11, and 10 may be respectively mapped to four cyclically shifted sequences having a difference of 3 from each other in cyclic shift values.

PUCCH format 1 may be used to transmit 1-bit or 2-bit HARQ-ACK information or SR. PUCCH format 1 may be transmitted through consecutive OFDM symbols on the time axis and one PRB on the frequency axis. Here, the number of OFDM symbols occupied by PUCCH format 1 may be one of 4 to 14.

Specifically, UCI with M_{bit}=1 may be modulated using binary phase shift keying (BPSK). The terminal may modulate UCI with M_{bit}=2 using quadrature phase shift keying (QPSK). A signal is obtained by multiplying the modulated complex valued symbol d(0) by a sequence with a length of 12. In this case, the sequence may be a base sequence used for PUCCH format 0. The terminal transmits the obtained signal by spreading the signal on the even-numbered OFDM symbols to which PUCCH format 1 is allocated using a time axis orthogonal cover code (OCC). In PUCCH format 1, the maximum number of different terminals multiplexed with the same RB is determined based on the length of the OCC used. A demodulation reference signal (DMRS) may be spread and mapped to odd-numbered OFDM symbols of PUCCH format 1 using an OCC.

PUCCH format 2 may be used to transmit UCI in excess of 2 bits. PUCCH format 2 may be transmitted through one or two OFDM symbols on the time axis and one RB or a plurality of RBs on the frequency axis. When PUCCH format 2 is transmitted through two OFDM symbols, the same sequence may be transmitted in different RBs through the two OFDM symbols. Here, the sequence may be a plurality of modulated complex valued symbols d(0), . . . , d(M_{symbol}−1). Here, M_{symbol} may be M_{bit}/2. Through this, the terminal may obtain a frequency diversity gain. In detail, the M_{bit}-bit UCI (M_{bit}>2) is bit-level scrambled, modulated using QPSK, and mapped to RB(s) of one or two OFDM symbol(s). Here, the number of RBs may be one of 1 to 16.

PUCCH format 3 or PUCCH format 4 may be used to transmit UCI in excess of 2 bits. PUCCH format 3 or PUCCH format 4 may be transmitted through consecutive OFDM symbols on the time axis and one PRB on the frequency axis. The number of OFDM symbols occupied by PUCCH format 3 or PUCCH format 4 may be one of 4 to 14.

In detail, the terminal may generate complex symbols d(0) to d(M_{symbol}−1) by modulating M_{bit}-bit UCI (M_{bit}>2) using π/2-BPSK or QPSK. Here, when π/2-BPSK is used, M_{symbol}=M_{bit}, and when QPSK is used, M_{symbol}=M_{bit}/2. The terminal may not apply block-wise spreading to PUCCH format 3. However, the terminal may apply block-wise spreading to one RB (that is, 12 subcarriers) using PreDFT-OCC with a length of 12 so that PUCCH format 4 may have 2 or 4 multiplexing capacities. The terminal may transmit the spread signal by performing transmit precoding (or DFT-precoding) on the spread signal and mapping the spread signal to each RE.

In this case, the number of RBs occupied by PUCCH format 2, PUCCH format 3, or PUCCH format 4 may be determined based on a maximum code rate and the length of UCI transmitted by the terminal. When the terminal uses PUCCH format 2, the terminal may transmit HARQ-ACK information and CSI information together through the PUCCH.

When the number of RBs to be transmitted by the terminal is greater than the maximum number of available RBs in PUCCH format 2, PUCCH format 3, or PUCCH format 4, the terminal may not transmit a portion of UCI according to the priority of the UCI but may transmit the remaining UCI.

PUCCH format 1, PUCCH format 3, or PUCCH format 4 may be configured through an RRC signal to indicate frequency hopping within a slot. When frequency hopping is configured, an index of an RB subject to frequency hopping may be configured as the RRC signal. When PUCCH format 1, PUCCH format 3, or PUCCH format 4 is transmitted over N OFDM symbols on the time axis, a first hop may have floor(N/2) OFDM symbols, and a second hop may have ceil(N/2) OFDM symbols.

PUCCH format 1, PUCCH format 3, or PUCCH format 4 may be configured to be repeatedly transmitted in a plurality of slots. In this case, the number K of slots in which the PUCCH is repeatedly transmitted may be configured by the RRC signal.

The PUCCH that is repeatedly transmitted should start with an OFDM symbol at the same position in each slot and have the same length. If any one of the OFDM symbols of the slot in which the terminal needs to transmit the PUCCH is indicated as a DL symbol by the RRC signal, the terminal may transmit the PUCCH in the next slot through delay, rather than transmitting the PUCCH in the corresponding slot.

Meanwhile, in the 3GPP NR system, the terminal may perform transmission/reception using a bandwidth less than or equal to the bandwidth of a carrier (or cell). For this, the terminal may be configured with a bandwidth part (BWP) including a portion of consecutive bandwidths among the bandwidth of the carrier.

A terminal that operates according to TDD or operates in an unpaired spectrum may be configured with up to four DL/UL BWP pairs per carrier (or cell). Further, the terminal may activate one DL/UL BWP pair. A terminal that operates according to FDD or operates in a paired spectrum may be configured with up to four DL BWPs in a downlink carrier (or cell) and configured with up to four UL BWPs in an uplink carrier (or cell).

The terminal may activate one DL BWP and one UL BWP for each carrier (or cell). The terminal may not perform reception or transmission in time-frequency resources other than the activated BWP. The activated BWP may be referred to as an active BWP.

The base station may indicate an activated BWP among the BWPs with which the terminal is configured through downlink control information (DCI). The BWP indicated through the DCI is activated, and other configured BWP(s) are deactivated. In a carrier (or cell) that operates in TDD, the base station may include a bandwidth part indicator (BPI) indicating the activated BWP in DCI scheduling a PDSCH or PUSCH to change the DL/UL BWP pair of the terminal.

The terminal may receive DCI scheduling a PDSCH or a PUSCH and identify a DL/UL BWP pair activated based on the BPI. In a downlink carrier (or cell) that operates in FDD, the base station may include the BPI indicating the activated BWP in DCI scheduling a PDSCH to change the DL BWP of the terminal.

In an uplink carrier (or cell) that operates in FDD, the base station may include the BPI indicating the activated BWP in DCI scheduling a PUSCH to change the UL BWP of the terminal.

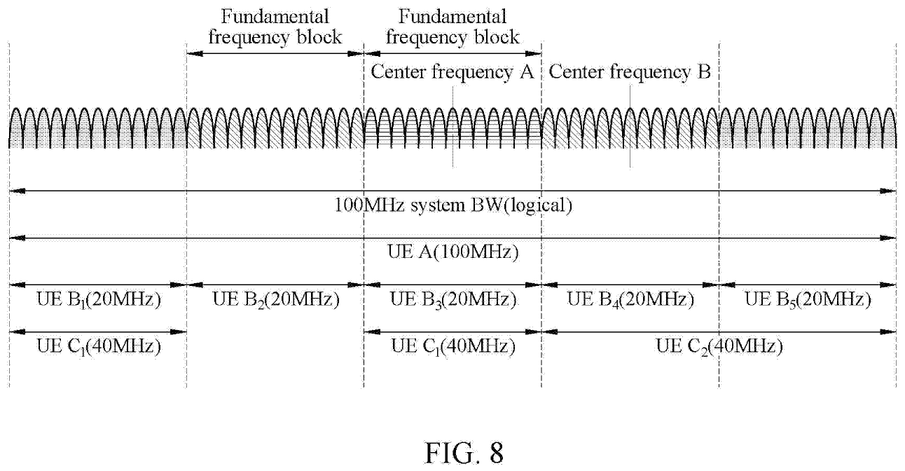

FIG. 8 is a diagram to describe carrier aggregation.

Carrier aggregation refers to a method of a terminal using a plurality of frequency blocks or cells (in a logical sense) as a single huge logic frequency band such that a wireless communication system may use a wider frequency band, wherein the frequency blocks or cells are configured with uplink resources (or component carriers) and/or downlink resources (or component carriers).

One component carrier (CC) may also be referred to as a primary cell (PCell), a secondary cell (SCell), or a primary SCell (PScell). However, hereinafter, for ease of description, the term “component carrier” will be used.

FIG. 8 shows an example of a 3GPP NR system in which the entire system band includes up to 16 component carriers, and each component carrier has a bandwidth of up to 400 MHz. A component carrier may include one or more physically consecutive subcarriers.

Although FIG. 8 illustrates component carriers having the same bandwidth, the component carriers may have different bandwidth. Further, although FIG. 8 illustrates the component carriers being logically adjacent to each other on the frequency axis, the component carriers may be physically adjacent to or separated from each other.

Different center frequencies may be used for the component carriers. In addition, one common center frequency may be used for physically adjacent component carriers.

Assuming that all component carriers are physically adjacent, a center frequency A may be used for all the component carriers. Further, assuming that component carriers are not physically adjacent to each other, the center frequency A and a center frequency B may be respectively used for the component carriers.

When the entire system band is extended by carrier aggregation, a frequency band used for communication with each terminal may be defined in the unit of a component carrier.

A terminal A may use the entire system band of 100 MHz and perform communication using all five component carriers. Terminals B1 to B5 may use only a bandwidth of 20 MHz and may perform communication using one component carrier. Terminals C1 and C2 may use a bandwidth of 40 MHz and may each perform communication using two component carriers.

The two component carriers may or may not be logically/physically adjacent. In FIG. 8, a case where the terminal C1 uses two non-adjacent component carriers, and the terminal C2 uses two adjacent component carriers is illustrated.

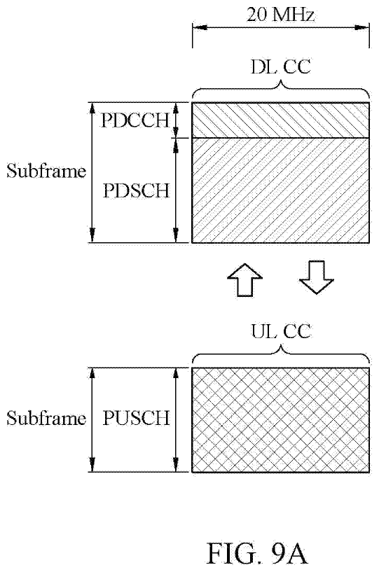

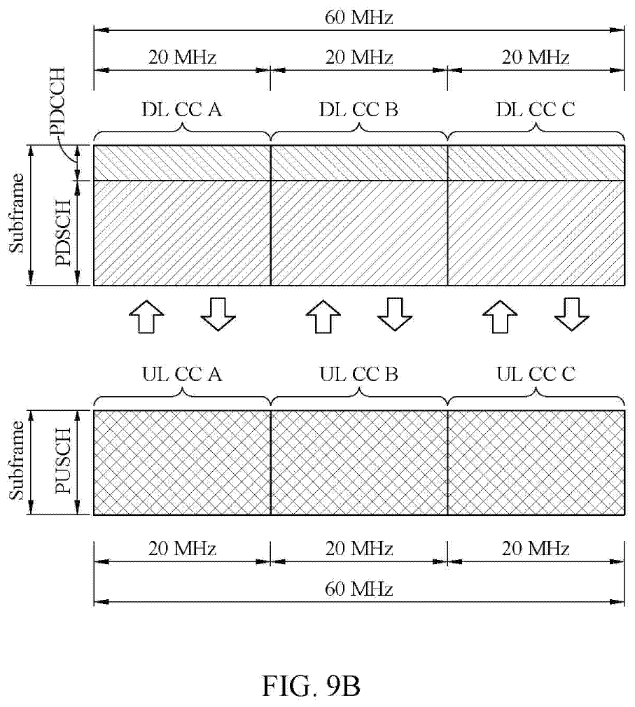

FIG. 9A is a diagram illustrating an example of a single-carrier subframe structure, and FIG. 9B is a diagram illustrating an example of a multi-carrier subframe structure.

A typical wireless communication system (for example, an FDD mode) may transmit or receive data through one DL band and one UL band corresponding thereto. As another example, a wireless communication system (for example, a TDD mode) may divide a radio frame into an uplink time unit and a downlink time unit in a time domain, and transmit or receive data through the uplink/downlink time unit.

Referring to FIG. 9B, for each of UL and DL, three 20-MHz component carriers (CC) may be collected to support a bandwidth of 60 MHz. The CCs may or may not be adjacent to each other in a frequency domain.

Although FIG. 9B illustrates a case where the UL CCs and the DL CCs all have the same and symmetric bandwidth, the bandwidth of each CC may be independently determined. In addition, asymmetric carrier aggregation in which the number of UL CCs differs from the number of DL CCs may also be possible. A DL/UL CC allocated/configured to a specific terminal through RRC may be referred to as a serving DL/UL CC of the specific terminal.

A base station may communicate with a terminal by activating a portion or all of the serving CCs of the terminal or deactivating a portion of the CCs. The base station may change CCs to be activated/deactivated, and change the number of CCs to be activated/deactivated.

If the base station allocates a CC available to the terminal as a cell-specific or UE-specific CC, at least one of the CCs that are already allocated may not be deactivated unless CC allocation for the terminal is reconfigured or the terminal performs handover.

The one CC that is not deactivated for the terminal may be referred to as a primary CC (PCC) or a primary cell (PCell), and a CC that may be freely activated/deactivated by the base station may be referred to as a secondary CC (SCC) or a secondary cell (SCell).

Meanwhile, 3GPP NR uses the concept of a cell to manage radio resources. A cell is defined as a combination of a downlink resource and an uplink resource, that is, a combination of a DL CC and a UL CC.

The cell may be configured with DL resources alone or a combination of a DL resource and a UL resource. When carrier aggregation is supported, a linkage between a carrier frequency of the DL resource (or DL CC) and a carrier frequency of the UL resource (or UL CC) may be indicated by system information.

The carrier frequency may be a center frequency of each cell or CC. A cell corresponding to a PCC may be referred to as a PCell, and a cell corresponding to an SCC may be referred to as an SCell. A carrier corresponding to a PCell in downlink is a DL PCC, and a carrier corresponding to a PCell in uplink is a UL PCC.

Similarly, a carrier corresponding to an SCell in downlink is a DL SCC, and a carrier corresponding to an SCell in uplink is a UL SCC. Depending on the terminal capability, serving cell(s) may include one PCell and zero or more SCells.

UE that is in the RRC_CONNECTED state but does not configure or support carrier aggregation may have a single serving cell including a PCell only.

As mentioned above, the term “cell” used in carrier aggregation may be distinguished from the term “cell” that refers to a predetermined geographic area in which a communication service is provided by one base station or one antenna group. That is, one component carrier (CC) may also be referred to as a scheduling cell, a scheduled cell, a primary cell (PCell), a secondary cell (SCell), or a primary SCell (PScell).

However, to distinguish between the cell indicating a predetermined geographic area and the cell in carrier aggregation herein, the cell in carrier aggregation may be referred to as a CC, and the cell of a geographic area may be referred to as a cell.

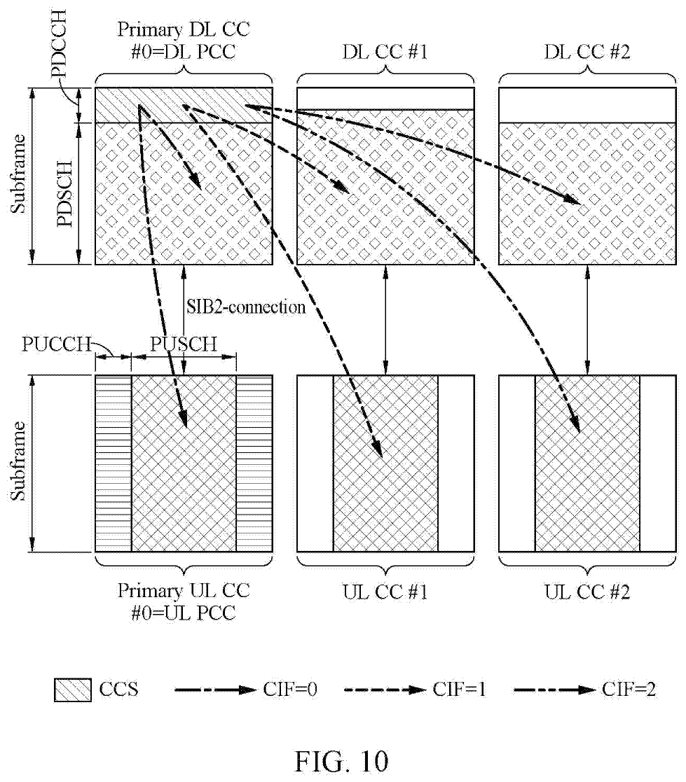

FIG. 10 is a diagram illustrating an example of a method to which cross-carrier scheduling is applied.

When cross-carrier scheduling is configured, a control channel transmitted through a first CC may schedule a data channel transmitted through the first CC or a second CC using a carrier indicator field (CIF).

The CIF may be included in DCI. For example, a scheduling cell may be configured, and a DL grant/UL grant transmitted in a PDCCH region of the scheduling cell may schedule a PDSCH/PUSCH of a scheduled cell. That is, a search region for a plurality of component carriers may exist in the PDCCH region of the scheduling cell. A PCell is basically a scheduling cell, and a specific SCell may be designated as a scheduling cell by an upper layer.

In FIG. 10, it is assumed that three DL CCs are merged. Here, it is assumed that a DL component carrier #0 is a DL PCC (or PCell), and a DL component carrier #1 and a DL component carrier #2 are DL SCCs (or SCells). Further, it is assumed that the DL PCC is set as a PDCCH monitoring CC.

If cross-carrier scheduling is not configured by UE-specific (or UE-group-specific or cell-specific) upper layer signaling, a CIF may be disabled, and each DL CC may transmit only a PDCCH scheduling its own PDSCH without the CIF according to NR PDCCH rules (non-cross-carrier scheduling or self-carrier scheduling).

On the other hand, when cross-carrier scheduling is configured by UE-specific (or UE-group-specific or cell-specific) upper layer signaling, a CIF may be enabled, and a specific CC (for example, DL PCC) may transmit a PDCCH scheduling a PDSCH of a DL CC A and a PDCCH scheduling a PDSCH of another CC using the CIF (cross-carrier scheduling).

Conversely, a PDCCH may not be transmitted in the other DL CC. Accordingly, a terminal may receive the self-carrier scheduled PDSCH by monitoring the PDCCH that does not include the CIF based on whether cross-carrier scheduling is configured for the terminal, or receive a cross-carrier scheduled PDSCH by monitoring the PDCCH including the CIF.

Meanwhile, FIGS. 9A to 10 illustrate an example of a subframe structure in a 3GPP LTE-A system. However, the same or similar configuration may also be applied to a 3GPP NR system. However, in the 3GPP NR system, the subframes of FIGS. 9A to 10 may be replaced with slots.

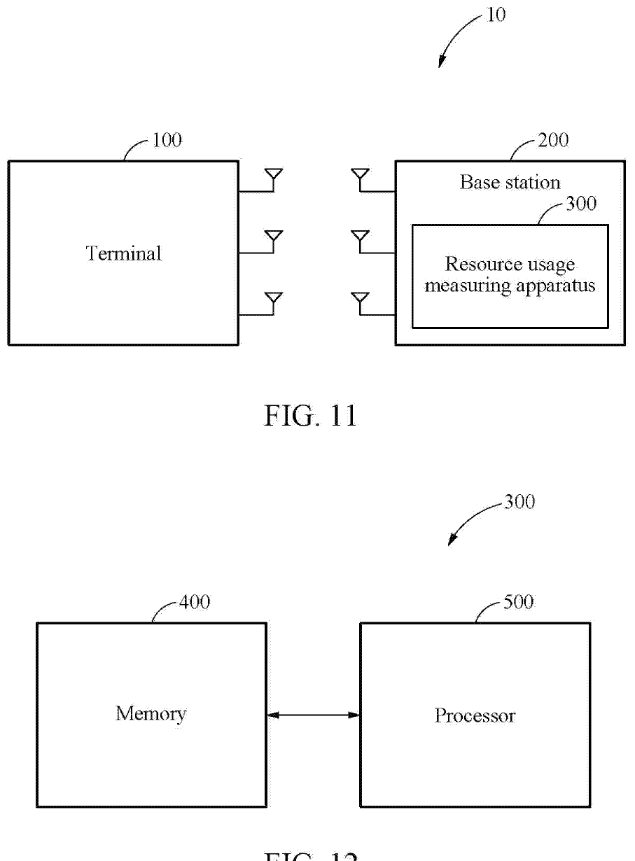

FIG. 11 is a schematic block diagram illustrating a wireless communication system in which a resource usage measuring apparatus according to an example embodiment is implemented, and FIG. 12 is a schematic block diagram illustrating the resource usage measuring apparatus of FIG. 11.

A wireless communication system 10 may be a 3GPP NR system, but is not limited thereto.

The wireless communication system 10 may include a terminal 100 and a base station 200.

The terminal 100 may be implemented as various types of wireless communication devices or computing devices that guarantee portability and mobility. The terminal may be referred to as user equipment (UE), a station (STA), a mobile subscriber (MS), or the like.

The base station 200 may control and manage a cell (for example, a macrocell, a femtocell and/or a picocell) corresponding to a service area, and perform functions such as signal transmission, channel designation, channel monitoring, self-diagnosis, and/or relay. The base station may be referred to as a next generation NodeB (gNB) or an access point (AP).

Further, although FIG. 11 shows a resource usage measuring apparatus 300 that is implemented in the base station 200, the resource usage measuring apparatus 300 may be separately implemented outside the base station 200. Further, the resource usage measuring apparatus 300 may be implemented in the terminal 100.

The base station 200 may include the resource usage measuring apparatus 300.

The resource usage measuring apparatus 300 may measure a frequency resource usage (or usage rate) of the base station 200 in the wireless communication system 10.

The resource usage measuring apparatus 300 may measure a usage of radio frequency resources used by the wireless communication system 100, thereby providing frequency resource distribution and flexible resource policy establishment for the wireless communication system 100.

The resource usage measuring apparatus 300 may include a memory 400 and a processor 500.

The memory 400 may store instructions (or programs) executable by the processor 500. For example, the instructions may include instructions to perform the operation of the processor 500 and/or the operation of each element of the processor 500.

The processor 500 may process data stored in the memory 400. The processor 500 may execute a computer-readable code (for example, software) stored in the memory 400 and instructions triggered by the processor 500.

The processor 500 may be a data processing device implemented by hardware including a circuit having a physical structure to perform desired operations. For example, the desired operations may include instructions or codes included in a program.

For example, the hardware-implemented data processing device may include a microprocessor, a central processing unit (CPU), a processor core, a multi-core processor, a multiprocessor, an application-specific integrated circuit (ASIC), and a field-programmable gate array (FPGA).

When the resource usage measuring apparatus 300 is implemented in the base station 200, the memory 400 and the processor 500 may be implemented separately from the elements of the base station 200, or may be implemented as the existing memory 230 and the existing processor 210 included in the base station 200.

Further, when the resource usage measuring apparatus 300 is implemented in the terminal 100, the memory 400 and the processor 500 may be implemented separately from the elements of the terminal 100, or may be implemented as the existing memory 130 and the existing processor 110 included in the terminal 100.

FIG. 13 is a diagram to describe a resource usage measuring method performed by the resource usage measuring apparatus of FIG. 11.

In detail, FIG. 13 shows an example of a demodulation reference signal (DM-RS) of a PDSCH used in the wireless communication system 10.

A sequence used for the DM-RS of the PDSCH may be generated based on a scrambling ID. For example, the terminal 100 may be configured with two scrambling IDs N_{ID}⁰ and N_{ID}¹ from an upper layer. The two scrambling IDs N_{ID}⁰ and N_{ID}¹ may be set to one of 0, 1, . . . , 65535.

If the above two scrambling IDs are not configured from the upper layer, the terminal 100 may determine N_{ID}⁰ and N_{ID}¹ to be a cell ID N_{ID}^{cell}.

The terminal 100 may generate the sequence used for the DM-RS of the PDSCH based on the two scrambling IDs, as expressed by Equation 3.

$$r ( n ) = \frac{1}{\sqrt{2}} ( 1 - 2 \cdot c ( 2 n ) ) + j \frac{1}{\sqrt{2}} ( 1 - 2 \cdot c ( 2 n + 1 ) ) \qquad [ Equation 3 ]$$

Here, c(i) denotes a pseudo-random sequence, and the pseudo-random sequence may be initialized to c [symbol] =(2 [symbol] (N [symbol] +I+1)(2N [symbol] +1)+2N [symbol] +n [symbol] )mod 2 [symbol] . N_{symb}^{slot} denotes the number of symbols per slot, n_{s,f}^{μ} denotes an index of a slot in a frame, and 1 may be an index of an OFDM symbol through which a DM-RS is transmitted in a slot. n_{SCID} may be a value of 0 or 1 and indicated by downlink control information (DCI). If not indicated, the terminal 100 may assume the value as 0.

The sequence r(n) of the DM-RS of the PDSCH may be mapped to a resource element (RE). If an index of the RE to which the DM-RS is transmitted is (k,l), the DM-RS transmitted in the RE (k,l) may be expressed by Equation 4.

$$\text{?} = {β}_{PUSCH}^{DMRS} {w}_{i} ( {k}^{′} ) {w}_{i} ( {l}^{′} ) r ( 2 n + {k}^{′} ) \\ k = \{ \begin{matrix}4 n + 2 {k}^{′} + Δ & Configuration type 1 \\ 6 n + {k}^{′} + Δ & Configuration type 2\end{matrix} \\ {k}^{′} = 0 , 1 \\ l = \overline{l} + {l}^{′} \\ n = 0 , 1 , … \\ \text{?} \text{indicates text missing or illegible when filed} \qquad [ Equation 4 ]$$

Here, Configuration type 1 and Configuration type 2 may indicate the arrangements of the DM-RS, and may be indicated by an upper layer. B_{PDSCH}^{DMRS} denotes transmission power, and w_{f}(k′) and wₜ(l′) denote an orthogonal cover code (OCC) in a frequency domain and an OCC in a time domain, respectively. w_{f}(k′), wₜ(l′), and Δ may have values given in Tables 4 and 5 depending on the configuration type.

TABLE 4

| | CDM | | | | | |
|---|---|---|---|---|---|---|
| | group | | w_{f}(k′) | | wₜ(l′) | |
| p | λ | Δ | k′ = 0 | k′ = 1 | l′ = 0 | l′ = 1 |
| 1000 | 0 | 0 | +1 | +1 | +1 | +1 |
| 1001 | 0 | 0 | +1 | −1 | +1 | +1 |
| 1002 | 1 | 1 | +1 | +1 | +1 | +1 |
| 1003 | 1 | 1 | +1 | −1 | +1 | +1 |
| 1004 | 0 | 0 | +1 | +1 | +1 | −1 |
| 1005 | 0 | 0 | +1 | −1 | +1 | −1 |
| 1006 | 1 | 1 | +1 | +1 | +1 | −1 |
| 1007 | 1 | 1 | +1 | −1 | +1 | −1 |

TABLE 5

| | CDM | | | | | |
|---|---|---|---|---|---|---|
| | group | | w_{f}(k′) | | wₜ(l′) | |
| p | λ | Δ | k′ = 0 | k′ = 1 | l′ = 0 | l′ = 1 |
| 1000 | 0 | 0 | +1 | +1 | +1 | +1 |
| 1001 | 0 | 0 | +1 | −1 | +1 | +1 |
| 1002 | 1 | 2 | +1 | +1 | +1 | +1 |
| 1003 | 1 | 2 | +1 | −1 | +1 | +1 |
| 1004 | 2 | 4 | +1 | +1 | +1 | +1 |
| 1005 | 2 | 4 | +1 | −1 | +1 | +1 |
| 1006 | 0 | 0 | +1 | +1 | +1 | −1 |
| 1007 | 0 | 0 | +1 | −1 | +1 | −1 |
| 1008 | 1 | 2 | +1 | +1 | +1 | −1 |
| 1009 | 1 | 2 | +1 | −1 | +1 | −1 |
| 1010 | 2 | 4 | +1 | +1 | +1 | −1 |
| 1011 | 2 | 4 | +1 | −1 | +1 | −1 |

The index (k,l) of the RE through which the DM-RS is transmitted may be determined as follows. k may be the index of the RE in the frequency domain, and l may be the index of the OFDM symbol in the time domain where the RE is included.

The frequency domain index k of the RE through which the DM-RS is transmitted may be charged from 0 of a subcarrier of a common resource block 0. The common resource block may be a resource block indicating a reference of a frequency domain commonly used by all terminals in a cell.

In the case of downlink, the common resource block 0 may be indicated by using a difference from CORESET0 in SIB1 during cell access. In the case of uplink, the common resource block 0 may be indicated by using an absolute radio frequency channel number (ARFCN) in SIB1 during cell access.

When the terminal 100 does not know the location of the common resource block 0 (for example, in case of initial cell access), the index may be charged from the subcarrier 0 of the lowest resource block of the CORESET of the PDCCH scheduling the PDSCH.

The time domain index l of the RE through which the DM-RS is transmitted may be determined depending on the mapping type of the PDSCH. In the case of PDSCH mapping type A, l may be assigned from a first symbol of a slot (for example, l=0 may indicate the first symbol of the slot). l₀ may have a value of 2 or 3 depending on the upper layer.

In the case of PDSCH mapping type B, l may be assigned based on the very first symbol among the resources for which the PDSCH is scheduled (for example, l=0 may indicate the first symbol scheduled for the PDSCH). Also, l₀ may be 0.

The time domain index l of the RE through which the DM-RS is transmitted may be determined based on the sum of l̅ and l′. Here, l′ may indicate the number of symbols through which the DM-RS is transmitted.

When the terminal 100 is configured with a single symbol DM-RS, l′ may be 0, and when the terminal 100 is configured with a double symbol DM-RS, l′ may be 0 and 1.

l_{d} according to the number l̅ of symbols for which the PDSCH is scheduled may be determined through Table 6.

TABLE 6

| | DM-RS positions l̅ | | | | | | | |
|---|---|---|---|---|---|---|---|---|
| | PDSCH mapping type A | | | | PDSCH mapping type B | | | |
| | dmrs- | | | | dmrs- | | | |
| | AdditionalPosition | | | | AdditionalPosition | | | |
| l_{d} in symbols | 0 | 1 | 2 | 3 | 0 | 1 | 2 | 3 |
| 2 | — | — | — | — | l₀ | l₀ | | |
| 3 | l₀ | l₀ | l₀ | l₀ | — | — | | |
| 4 | l₀ | l₀ | l₀ | l₀ | l₀ | l₀ | | |
| 5 | l₀ | l₀ | l₀ | l₀ | — | — | | |
| 6 | l₀ | l₀ | l₀ | l₀ | l₀ | l₀, 4 | | |
| 7 | l₀ | l₀ | l₀ | l₀ | l₀ | l₀, 4 | | |
| 8 | l₀ | l₀, 7 | l₀, 7 | l₀, 7 | — | — | | |
| 9 | l₀ | l₀, 7 | l₀, 7 | l₀, 7 | — | — | | |
| 10 | l₀ | l₀, 9 | l₀, 6, 9 | l₀, 6, 9 | — | — | | |
| 11 | l₀ | l₀, 9 | l₀, 6, 9 | l₀, 6, 9 | — | — | | |
| 12 | l₀ | l₀, 9 | l₀, 6, 9 | l₀, 5, 8, 11 | — | — | | |
| 13 | l₀ | l₀, l₂ | l₀, 7, 11 | l₀, 5, 8, 11 | — | — | | |
| 14 | l₀ | l₀, l₂ | l₀, 7, 11 | l₀, 5, 8, 11 | — | — | | |

The wireless communication system may measure a usage rate of radio frequency resources based on the signal strengths of the frequency resources. A method of measuring each frequency resource may have a low reliability since the measurement result of each frequency resource changes according to the channel being specified, and have an issue of the frequency usage rate being measured high due to an interference signal from a base station or terminal other than the base station to be specified.

As another example, the wireless communication system may receive the PDCCH transmitted by the base station, extract information related to resource use, and measure an amount of the resources used by the base station. Since the wireless communication system should receive all PDCCHs transmitted by the base station, the complexity for decoding may be very high. In addition, due to a PDCCH configuration (for example, control resource set and search space configuration) different for each terminal, there are various combinations of time-frequency resources to monitor the PDDCH, and various configurations of fields (a field according to the bandwidth part configuration, a field associated with scheduling, a field associated with MIMO, a field associated with power control, and the like) of DCI transmitted by the PDCCH. Thus, it is difficult to receive PDCCHs of all terminals.

The wireless communication system 10 may measure the frequency resource usage rate of the base station 200 by receiving the DM-RS of the downlink data channel transmitted by the base station 200.

An LTE system uses a downlink data transmission method using a common reference signal (CRS). Therefore, since the LTE system transmits the CRS in all bands regardless of the allocation of the PDSCH transmitted by the base station, it is impossible to measure the usage of the time-frequency resources allocated by the base station by receiving the CRS.

In addition, the LTE system also uses a downlink data transmission method using a DM-RS. Since the DM-RS of the LTE system is transmitted only in some REs of the frequency resources, it may be insufficient to measure the PDSCH resource allocation information of the REs of all frequency resources.

The wireless communication system 10 (for example, the NR system) may not support a downlink data transmission method using a CRS, but only a downlink data transmission method using a DM-RS. In addition, the wireless communication system 10 may transmit a DM-RS in one symbol or a plurality of symbols and in REs arranged at equal intervals in the frequency domain.

Accordingly, the wireless communication system 10 may accurately know the frequency resources used by the base station 200 by receiving the DM-RS. Thus, it may be easy to measure the frequency resource usage rate of the base station.

Hereinafter, a method of measuring a frequency resource usage rate by receiving a DM-RS in the resource usage measuring apparatus 300 implemented in the wireless communication system 10 will be described.

The wireless communication system 10 may use two types of PDSCH resource allocation methods.

In the first method, the wireless communication system 10 may configure a resource block group (RBG) by grouping resource blocks (RBs), and indicate whether the RBGs are used for scheduling in DCI scheduling a PDSCH, using a bitmap. The first method may be bitmap-based scheduling.

In the second method, the wireless communication system 10 may indicate, in the unit of a single resource block, the index of a start resource block in which the PDSCH is scheduled and the number of consecutive resource blocks using DCI. The index of the start resource block and the number of consecutive resource blocks may be jointly encoded as a resource indication value (RIV) and indicated by DCI. The second method may be RIV-based scheduling.

The resource usage measuring apparatus 300 may determine a configuration of a bandwidth part (BWP) suitable for a frequency band used by the base station 200.

The base station 200 may support the terminal 100 using an available wide-band BWP. A narrow-band BWP may be configured to some terminals 100. In this case, the terminal 100 may be configured with the narrow-band BWP for reducing power consumption, rather than for transmitting data. That is, when the terminal 100 receives data transmission, a wide-band BWP supported by the base station 200 may be used instead of a narrow-band BWP.

The resource usage measuring apparatus 300 may preferably use a wide-band BWP configuration that may be used by the base station 200 to measure downlink resources.

The resource usage measuring apparatus 300 may use a BWP including all resource blocks of a frequency band used by the base station 200. In this case, it is premised that the base station 200 uses all resource blocks as much as possible. The resource usage measuring apparatus 300 may receive a physical broadcast channel (PBCH) transmitted by the base station 200 and infer the BWP configuration from the configuration of CORESET0. The resource usage measuring apparatus 300 may regard the band of CORESET0 as a downlink BWP when the terminal 100 initially accesses a cell. In this case, it is premised that the base station 200 does not change the downlink BWP determined to be the band of CORESET0 without any special reason.

The resource usage measuring apparatus 300 may receive SIB1 transmitted by the base station 200 and infer the BWP configuration from the initial DL BWP configuration. The terminal 100 may receive a PDCCH for transmitting SIB1 at CORESET0 indicated by the PBCH. In SIB1, the initial DL BWP configuration may be indicated in the unit of a single resource block. BWPs of all terminals accessing the base station 200 may be determined based on the initial DL BWP configuration indicated by SIB1.

The resource usage measuring apparatus 300 may infer the BWP configuration from the DL BWP configuration indicated by a UE-specific RRC signal transmitted by the base station 200. The terminal 100 may receive a UE-specific RRC signal from the base station in the random access process, and information therein may include information on the DL BWP. The resource usage measuring apparatus 300 may infer information on the BWP configuration used by the base station by using the information on the DL BWP.

The configuration of the BWP used by the base station 200 may determine a frequency band that the resource usage measuring apparatus 300 should receive for resource measurement. For example, when the resource usage measuring apparatus 300 measures the frequency usage rate of a wider frequency band than the BWP used by the base station 200, the frequency resource not used by the base station may be included, such that the frequency usage rate may be measured less.

The resource usage measuring apparatus 300 may determine whether the DM-RS is transmitted in a symbol in which the DM-RS is likely to be transmitted in the unit of a single resource block. The resource usage measuring apparatus 300 may determine whether a DM-RS is transmitted in all symbols.

The resource usage measuring apparatus 300 may use a correlation in the unit of a single resource block to determine whether a DM-RS is transmitted in a symbol in which the DM-RS is likely to be transmitted in the unit of a single resource block. Since the resource usage measuring apparatus 300 detects a DM-RS sequence of one resource block, a DM-RS sequence may not be detected in a specific situation (for example, a situation in which the channel condition is poor). The resource usage measuring apparatus 300 may detect the DN-RS sequence of one resource block by using the characteristics of the PDSCH scheduling method.

The resource usage measuring apparatus 300 may figure out the number of resource blocks (RBs) grouped into a resource block group (RBG) in the bitmap-based scheduling method.

The resource usage measuring apparatus 300 may determine the number of resource blocks included in the resource block group based on the BWP used by the base station 200. The terminal 200 may set one of two values as the number of resource blocks grouped into the resource block group. The resource usage measuring apparatus 300 may use the smaller value between the two values.

The resource usage measuring apparatus 300 may determine the maximum number of resource blocks grouped into a resource block group even though a plurality of resource blocks are grouped into one resource block group. For example, the resource usage measuring apparatus 300 may assume that up to 4 resource blocks may be grouped into one RBG.

When multiple resource blocks are grouped into one resource block group, and the frequency usage rate is determined in the unit of a resource block group, the frequency domain corresponding to one resource block group may be widened, and fluctuations resulting from fading in the frequency domain may increase the probability that false results are derived.

The resource usage measuring apparatus 300 may detect an index of a start resource block allocated to PDSCH scheduling and the number of consecutive resource blocks in the RIV-based scheduling method. That is, the resource usage measuring apparatus 300 may increase the reliability of DM-RS sequence detection by utilizing information indicating that it may be scheduled in consecutive resource blocks. For example, the resource usage measuring apparatus 300 may detect a DM-RS sequence in RB #0, RB #1, and RB #3, and may not detect a DM-RS sequence in RB #2. Since the RIV-based scheduling method schedules only consecutive resource blocks, the resource usage measuring apparatus 300 may determine the DM-RS sequence is successfully detected in RB #0, RB #1, RB #2, and RB #3 even if the DM-RS sequence detection fails in RB #2.

That is, if the DM-RS sequence is successfully detected in consecutive resource blocks on both sides of a resource block failing in detection of a DM-RS sequence, the resource usage measuring apparatus 300 may determine the resource block failing in detection to be an RB in which the DM-RS sequence is transmitted. The resource usage measuring apparatus 300 may perform scheduling in the unit of a single resource block in the RIV-based scheduling method and thus, may detect a DM-RS sequence in the unit of a single resource block.

When detecting a DM-RS sequence in the unit of a single resource block, the resource usage measuring apparatus 300 may fail the DM-RF sequence detection in a specific situation. In order to reduce such a failure, the bitmap-based scheduling method may detect a DM-RS sequence in the unit of a resource block group.

The resource usage measuring apparatus 300 may use K consecutive resource blocks to detect a DM-RS sequence in the RIV-based scheduling method. For example, when a BWP includes 20 RBs (RB #0 to RB #19), and K is 4, the resource usage measuring apparatus 300 may use K consecutive resource blocks to detect a DM-RS sequence.

That is, the resource usage measuring apparatus 300 may detect a DM-RS sequence using {RB #0, RB #1, RB #2, RB #3} as first resource blocks. In addition, the resource usage measuring apparatus 300 may detect a DM-RS sequence using {RB #1, RB #2, RB #3, RB #4} as second RBs, and detect a DM-RS sequence using {RB #16, RB #17, RB #18, RB #19}.

The resource usage measuring apparatus 300 may detect the DM-RSs using the plurality of consecutive resource blocks, thereby increasing the DM-RS sequence detection probability.

In the aspect of frequency resource usage rate measurement, even when resource allocation information is added even if the resource allocation is smaller than K RBs, the result value of the resource usage measuring apparatus 300 may not be significantly affected. In the frequency resource usage rate measurement of the resource usage measuring apparatus 300, it is important to detect a PDSCH scheduled for multiple resources that may greatly affect the result value.

The resource usage measuring apparatus 300 may determine the DM-RS detection using a correlation. The resource usage measuring apparatus 300 may measure a correlation between a signal x(i) received from resource elements (REs) of a symbol in which the DM-RS of the PDSCH is likely to be transmitted and a DM-RS sequence c(i) expected to be transmitted by the base station.

The resource usage measuring apparatus 300 may estimate a channel h(i) of the RE using x(i), and then use a maximum likelihood detector under the assumption that h(i) is an actual channel.

For example, the resource usage measuring apparatus 300 may use the sum of |x(i)−h(i)c(i)|² as the correlation. The resource usage measuring apparatus 300 may determine that the DM-RS sequence is transmitted when the sum of |x(i)−h(i)c(i)|² is relatively small. Since the resource usage measuring apparatus 300 needs to perform channel estimation for each symbol, high complexity may occur. The resource usage measuring apparatus 300 may use a difference in phase information to measure the correlation with low complexity.

The DM-RS sequence c(i) may be modulated using with QPSK (for example, one of 1+j, 1−j, −1+j, and −1−j) and transmitted. Therefore, c(i) and c(i+1) may have a phase difference of 0, pi/2, pi, or 3pi/2. If a signal x(i) is received in response to c(i) being transmitted, x(i) may also have a phase difference of 0, pi/2, pi, or 3 μl/2 (if the noise effect is ignored).

The resource usage measuring apparatus 300 may detect a DM-RS using the phase difference. For example, if the length of c(i) is M, M is the number of REs grouped together to detect a DM-RS and may vary according to the number of resource blocks included in the resource block group.

The phase difference between c(i) and c(i+1) may be expressed as d(i), and the phase difference between x(i) and x(i+1) may be expressed as y(i). The resource usage measuring apparatus 300 may determine the correlation to be the sum of |d(i)−y(i)|². That is, the resource usage measuring apparatus 300 may define a distance difference between two phase differences to be the correlation. The resource usage measuring apparatus 300 may determine that the DM-RS sequence is transmitted when the sum of |d(i)−y(i)|² is relatively small.

When the resource usage measuring apparatus 300 detects a DM-RS sequence, the resource usage measuring apparatus 300 may at least know information on resource blocks used by the base station for scheduling.

In an LTE system, all symbols of one subframe (1 ms) may always be identically scheduled. In the wireless communication system 10 (for example, NR system), the concept of a mini-slot may be introduced so that each symbol may be differently scheduled within one slot. Therefore, even if a DM-RS sequence is detected in one slot of the wireless communication system 10, it is impossible to know which symbols of the slot are allocated. To solve this, the resource usage measuring apparatus 300 may measure a resource usage in the time domain resources.

Table 7 shows combinations for a base station to schedule a PDSCH and a PUSCH to a terminal in the NR system. Hereinafter, PDSCH scheduling will be described, and the same description may apply to PUSCH scheduling.

Referring to Table 7, there are 31 possible allocation combinations for PDSCH mapping type A and 33 possible allocation combinations for PDSCH mapping type B. There are a total of 62 possible allocation combinations. At this time, there may be two cases in which mapping types A and B allocate the same scheduling.

According to Table 7, the base station 200 may schedule limited combinations for the terminal 100. For example, when the resource usage measuring apparatus 300 detects DM-RS in a first symbol, a possible PDSCH allocation may correspond to PDSCH mapping type B and have a length of 2, 4, or 7. That is, the resource usage measuring apparatus 300 may determine that the PDSCH is allocated according to one of combinations {symbol #0, symbol #1}, {symbol #0, symbol #1, symbol #2, symbol #3}, and {symbol #0, symbol #1, symbol #2, symbol #3, symbol #4, symbol #5, symbol #6.

TABLE 7

| Detected | Possible candidates | | |
|---|---|---|---|
| DMRS | PDSCH mapping | PDSCH mapping | # of |
| position | Type B | Type A | candidates |
| 0 | Length 2, 4, 7 | | 3 |
| 1 | Length 2, 4, 7 | | 3 |
| 2 | Length 2, 4, 7 | S = 0, L = {3,4,5,6,7,8,9,10,11,12,13,14} | 34 |
| | | S = 1, L = {3,4,5,6,7,8,9,10,11,12,13} | |
| | | S = 2, L = {3,4,5,6,7,8,9,10,11,12} | |
| | | *Type A S = 2 & L = 4 = TypeB length 4 | |
| | | *Type A S = 2 & L = 7 = TypeB length 7 | |
| 3 | Length 2, 4, 7 | | 3 |
| 4 | Length 2, 4, 7 | | 3 |
| 5 | Length 2, 4, 7 | | 3 |
| 6 | Length 2, 4, 7 | | 3 |
| 7 | Length 2, 4, 7 | | 3 |
| 8 | Length 2, 4 | | 2 |
| 9 | Length 2, 4 | | 2 |
| 10 | Length 2, 4 | | 2 |
| 11 | Length 2 | | 1 |
| 12 | Length 2 | | 1 |
| 13 | Length 2 | | 1 |

The base station 200 may not use all the combinations of Table 7 for scheduling. For example, the terminal 100 may receive up to 16 different PDSCH scheduling combinations through a 4-bit time domain resource assignment (TDRA) field of DCI scheduling the PDSCH. Further, when the base station 200 does not configure up to 16 PDSCH scheduling combinations to the terminal 100 through separate signaling, the terminal 100 may use a default PDSCH TDRA table. Table 8 shows the default PDSCH TDRA table.

TABLE 8

| Row | dmrs-TypeA- | PDSCH | | | |
|---|---|---|---|---|---|
| index | Position | mapping type | K₀ | S | L |
| 1 | 2 | Type A | 0 | 2 | 12 |
| | 3 | Type A | 0 | 3 | 11 |
| 2 | 2 | Type A | 0 | 2 | 19 |
| | 3 | Type A | 0 | 3 | 9 |
| 3 | 2 | Type A | 0 | 2 | 9 |
| | 3 | Type A | 0 | 3 | 8 |
| 4 | 2 | Type A | 0 | 2 | 7 |
| | 3 | Type A | 0 | 3 | 6 |
| 5 | 2 | Type A | 0 | 2 | 5 |
| | 3 | Type A | 0 | 3 | 4 |
| 6 | 2 | Type B | 0 | 9 | 4 |
| | 3 | Type B | 0 | 10 | 4 |
| 7 | 2 | Type B | 0 | 4 | 4 |
| | 3 | Type B | 0 | 6 | 4 |
| 8 | 2,3 | Type B | 0 | 5 | 7 |
| 9 | 2,3 | Type B | 0 | 5 | 2 |
| 10 | 2,3 | Type B | 0 | 9 | 2 |
| 11 | 2,3 | Type B | 0 | 12 | 2 |
| 12 | 2,3 | Type A | 0 | 1 | 13 |
| 13 | 2,3 | Type A | 0 | 1 | 6 |
| 14 | 2,3 | Type A | 0 | 2 | 4 |
| 15 | 2,3 | Type B | 0 | 4 | 7 |
| 16 | 2,3 | Type B | 0 | 8 | 4 |

The allocable PDSCH scheduling in Table 8 may be arranged as shown in Table 9. In this case, dmrs-TypeA-Position may be assumed to be 2.

There may be a symbol in which the DM-RS of the PDSCH is not located. That is, the DM-RS of the PDSCH may be located in a determined DM-RS symbol. For example, referring to Table 9 and FIG. 12, the DM-RS of the PDSCH may not be located in symbol #0, symbol #1, symbol #3, symbol #6, symbol #7, symbol #10, symbol #11, and symbol #13, and the DM-RS may be located in symbol #2, symbol #4, symbol #5, symbol #8, symbol #9, and symbol #12.

When detecting the DM-RS of the PDSCH, the resource usage measuring apparatus 300 may monitor only symbols in which the DM-RS is likely to be located. In addition, when receiving the DM-RS of the PDSCH in one symbol, the resource usage measuring apparatus 300 may obtain a PDSCH scheduling combination that is allocable from the DM-RS, and determine a symbol in which the DM-RS of the PDSCH is likely to be located using the combination.

For example, when the resource usage measuring apparatus 300 detects the DM-RS of the PDSCH in symbol #2, the resource usage measuring apparatus 300 may determine at least {symbol #2, symbol #3, symbol #4, symbol #5} to be used for PDSCH allocation unconditionally. Accordingly, the resource usage measuring apparatus 300 may need not detect whether the DM-RS is transmitted in symbol #4 and symbol #5. The DM-RS of the PDSCH may be transmitted in a total of 21 combinations {symbol #2}, {symbol #4}, {symbol #5}, {symbol #8}, {symbol #9}, {symbol #12}, {symbol #2, symbol #8}, {symbol #2, symbol #9}, {symbol #2, symbol #12}, {symbol #2, symbol #8, symbol #12}, {symbol #2, symbol #9, symbol #12}, {symbol #4, symbol #8}, {symbol #4, symbol #9}, {symbol #4, symbol #12}, {symbol #4, symbol #8, symbol #12},{symbol #5, symbol #8}, {symbol #5, symbol #9}, {symbol #5, symbol #12}, {symbol #5, symbol #8, symbol #12}, {symbol #8, symbol #12}, and {symbol #9, symbol #12}.

When the DM-RS of the PDSCH is received in one symbol, the resource usage measuring apparatus 300 may easily infer scheduling information of the one symbol. For example, when the resource usage measuring apparatus 300 detects the DM-RS of the PDSCH in symbol #8, possible PDSCH scheduling may be {symbol #8, symbol #9, symbol #10, symbol #11}.

TABLE 9

| Detected | Possible candidates | | |
|---|---|---|---|
| DMRS | PDSCH mapping | PDSCH mapping | # of |
| position | Type B | Type A | candidates |
| 0 | — | — | 0 |
| 1 | — | — | 0 |
| 2 | | (S,L) = (2,12), (2,10), (2,9), | 8 |
| | | (2,7), (2,5), (2,4), | |
| | | (S,L) = (1,13), (1,6) | |
| 3 | — | — | 0 |
| 4 | Length 4, 7 | | 2 |
| 5 | Length 2, 7 | | 2 |
| 6 | — | — | 0 |
| 7 | — | — | 0 |
| 8 | Length 4 | | 1 |
| 9 | Length 2, 4 | | 2 |
| 10 | — | | 0 |
| 11 | — | | 0 |
| 12 | Length 2 | | 1 |
| 13 | — | — | 0 |

Even if the resource usage measuring apparatus 300 detects the DM-RS symbol of the PDSCH, there may be a plurality of PDSCH combinations in the time domain. The resource usage measuring apparatus 300 may determine one of the combinations.

The resource usage measuring apparatus 300 may compare reception powers of respective symbols to determine the last symbol of the PDSCH. For example, when the reception power in symbol #4 is P and the reception power in symbol #5 is lower than or higher than P by a predetermined level, the resource usage measuring apparatus 300 may determine symbol #4 to be the last symbol of the PDSCH.

This may be inferred based on the fact that symbols allocated to the PDSCH should use the same power. However, when PDSCHs using the same power are consecutively scheduled, the last symbol of the PDSCH may not be accurately determined using the reception power.

The resource usage measuring apparatus 300 may determine the last symbol using a constellation of a signal transmitted in each symbol. The base station 200 may use one modulation to transmit the PDSCH to the terminal 100. For example, QPSK, 16QAM, 64QAM, and the like may be used.

The resource usage measuring apparatus 300 may determine the last symbols of the PDSCHs by monitoring the constellation of each of the symbols. The base station 200 may use the same beamforming and/or precoder when transmitting the PDSCH to the terminal 100. Accordingly, almost the same constellation may be shown in one PDSCH. A different modulation order or different beamforming may be used for another PDSCH, and thus a different constellation may be shown.

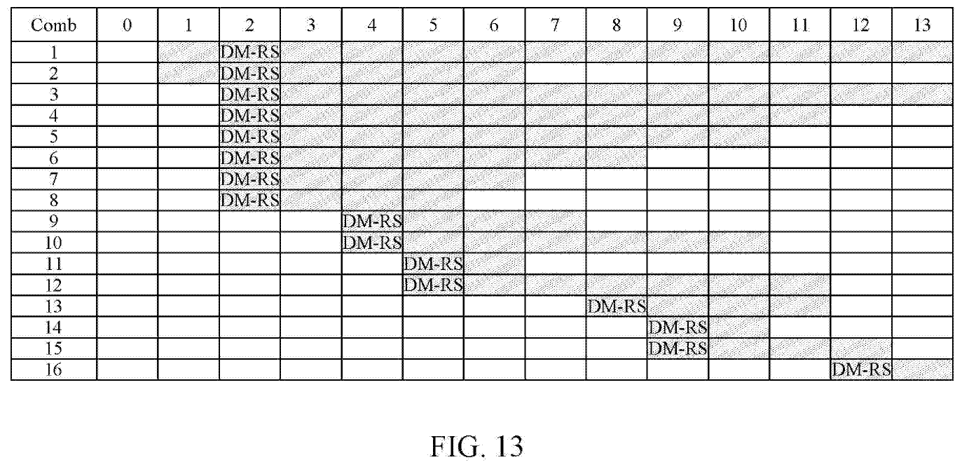

FIG. 14 is a block diagram illustrating the wireless communication system of FIG. 11.

The terminal 100 may include a processor 110, a communication module 120, a memory 130, a user interface 140, and a display 150.

The processor 110 and the memory 130 may be the processor 500 and the memory 400 shown in FIG. 12, respectively. For example, the resource usage measuring apparatus 300 may be implemented with the processor 110 and the memory 130.

The processor 110 may execute various instructions or programs and process data in the terminal 100. Further, the processor 110 may control the overall operation of the units of the terminal 100 and control data transmission and reception between the units. Here, the processor 110 may be configured to perform all functions of the terminal 100. For example, the processor 110 may receive slot configuration information, determine a slot configuration based on the received slot configuration information, and perform communication according to the determined slot configuration.

The communication module 120 may be an integrated module that performs wireless communication using a wireless communication network and wireless LAN connection using a wireless LAN. The communication module 120 may include a first communication module 121, a second communication module 122, and a third communication module 123.

For example, the first communication module 121 and the second communication module 122 may be cellular communication interface cards, and the third communication module 123 may be an unlicensed band communication interface card. That is, the communication module 120 may include a plurality of embedded or external network interface cards (NICs) including the cellular communication interface cards 121 and 122 and the unlicensed band communication interface card 123.

Although FIG. 14 illustrates the communication module 120 being an integrated module, the first to third communication modules 121 to 123 (for example, the network interface cards) may be independently disposed according to the circuit configuration or use.

The cellular communication interface card 121 may transmit and receive a radio signal to and from at least one of the base station 200, an external device, and a server using a mobile communication network, and provide a cellular communication service using a first frequency band based on an instruction from the processor 110.

The cellular communication interface card 121 may include at least one NIC module which uses a frequency band of less than 6 GHz. The at least one NIC module of the cellular communication interface card 121 may independently perform cellular communication with at least one of the base station 200, the external device, and the server according to a cellular communication standard or protocol of a frequency band of less than 6 GHz supported by the corresponding NIC module.

The cellular communication interface card 122 may transmit and receive a radio signal to and from at least one of the base station 200, an external device (not shown), and a server (not shown) using a mobile communication network, and provide a cellular communication service using a second frequency band based on an instruction from the processor 110.

The cellular communication interface card 122 may include at least one NIC module which uses a frequency band of 6 GHz or more. The at least one NIC module of the cellular communication interface card 122 may independently perform cellular communication with at least one of the base station 200, the external device, and the server according to a cellular communication standard or protocol of a frequency band of 6 GHz or more supported by the corresponding NIC module.

The unlicensed band communication interface card 123 may transmit and receive a radio signal to and from at least one of the base station 200, an external device, and a server using a third frequency band which is an unlicensed band, and provide a communication service of an unlicensed band based on an instruction from the processor 110.

The unlicensed band communication interface card 123 may include at least one NIC module which uses the unlicensed band. For example, the unlicensed band may be a band of 2.4 GHz or 5 GHz.

The at least one NIC module of the unlicensed band communication interface card 123 may independently or dependently perform radio communication with at least one of the base station 200, the external device, and the server according to an unlicensed band communication standard or protocol of a frequency band supported by the corresponding NIC module.

The memory 130 may store a control program used in the terminal 100 and various data relevant thereto. The control program may include a predetermined program required for the terminal 100 to perform radio communication with at least one of the base station 200, the external device, and the server.

The user interface 140 may include various types of input/output devices provided in the terminal 100. For example, the user interface 140 may receive a user input using various input devices, and the processor 110 may control the terminal 100 based on the received user input. In addition, the user interface 140 may perform an output based on the instruction from the processor 110 using various output devices.

The display 150 may display various images on a display screen. The display 150 may output various display objects such as content executed by the processor 110 or a user interface based on the control instruction from the processor 110.

The base station 200 may include a processor 210, a communication module 220, and a memory 230.

The processor 210 and the memory 230 may be the processor 500 and the memory 400 shown in FIG. 12, respectively. For example, the resource usage measuring apparatus 300 may be implemented with the processor 210 and the memory 230.

The processor 210 may execute various instructions or programs and process data in the base station 200. Further, the processor 210 may control the overall operation of the units of the base station 200 and control data transmission and reception between the units.

The processor 210 may be configured to perform functions of the base station 100. For example, the processor 210 may signal slot configuration information and perform communication according to the signaled slot configuration.

The communication module 220 may be an integrated module that performs wireless communication using a wireless communication network and wireless LAN connection using a wireless LAN. The communication module 220 may include a first communication module 221, a second communication module 222, and a third communication module 223.

For example, the first communication module 221 and the second communication module 222 may be cellular communication interface cards, and the third communication module 223 may be an unlicensed band communication interface card. That is, the communication module 220 may include a plurality of embedded or external network interface cards including the cellular communication interface cards 221 and 222 and the unlicensed band communication interface card 223.

Although FIG. 14 illustrates the communication module 220 being an integrated module, the first to third communication modules 221 to 223 (for example, the network interface cards) may be independently disposed according to the circuit configuration or use.

The cellular communication interface card 221 may transmit and receive a radio signal to and from at least one of the terminal 100, an external device (not shown), and a server (not shown) using a mobile communication network, and provide a cellular communication service using a first frequency band based on an instruction from the processor 210.

The cellular communication interface card 221 may include at least one NIC module which uses a frequency band of less than 6 GHz. The at least one NIC module of the cellular communication interface card 221 may independently perform cellular communication with at least one of the terminal 100, the external device, and the server according to a cellular communication standard or protocol of a frequency band of less than 6 GHz supported by the corresponding NIC module.

The cellular communication interface card 222 may transmit and receive a radio signal to and from at least one of the terminal 100, an external device (not shown), and a server (not shown) using a mobile communication network, and provide a cellular communication service using a second frequency band based on an instruction from the processor 210.

The cellular communication interface card 222 may include at least one NIC module which uses a frequency band of 6 GHz or more. The at least one NIC module of the cellular communication interface card 222 may independently perform cellular communication with at least one of the terminal 100, the external device, and the server according to a cellular communication standard or protocol of a frequency band of 6 GHz or more supported by the corresponding NIC module.

The unlicensed band communication interface card 223 may transmit and receive a radio signal to and from at least one of the terminal 100, an external device (not shown), and a server (not shown) using a third frequency band which is an unlicensed band, and provide a communication service of an unlicensed band based on an instruction from the processor 210.

The unlicensed band communication interface card 223 may include at least one NIC module which uses the unlicensed band. For example, the unlicensed band may be a band of 2.4 GHz or 5 GHz.

The at least one NIC module of the unlicensed band communication interface card 223 may independently or dependently perform radio communication with at least one of the terminal 100, the external device, and the server according to an unlicensed band communication standard or protocol of a frequency band supported by the corresponding NIC module.

FIG. 14 is a block diagram illustrating an example of the terminal 100 and the base station 200, wherein the blocks are illustrated separately to logically distinguish the elements of the device. Accordingly, the elements of the device described above may be mounted as one chip or as a plurality of chips depending on the design of the device. In addition, some elements of the terminal 100, for example, the user interface 140 and the display 150, may be selectively provided in the terminal 100. In addition, the user interface 140 and the display 150 may be additionally provided in the base station 200, as necessary.

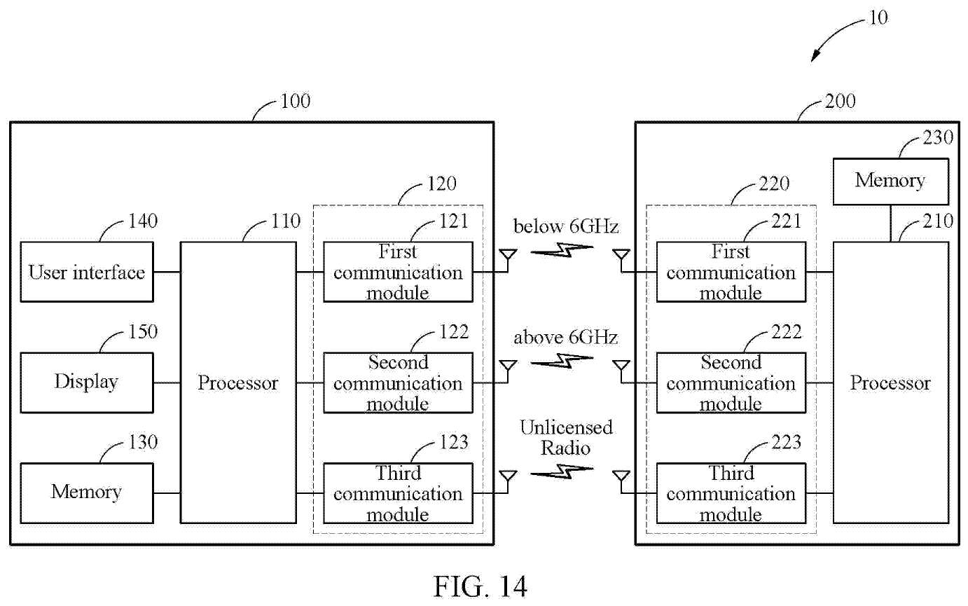

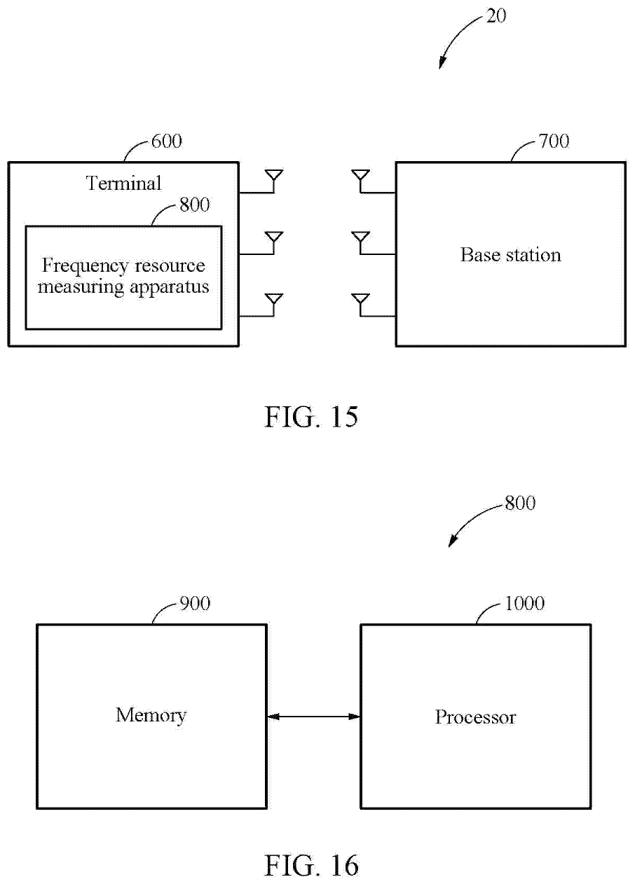

FIG. 15 is a schematic block diagram illustrating a wireless communication system in which a frequency resource measuring apparatus according to another example embodiment is implemented, and FIG. 16 is a schematic block diagram illustrating the frequency resource measuring apparatus of FIG. 15.

A wireless communication system 20 may include a terminal 600 and a base station 700.

The terminal 600 may be implemented as various types of wireless communication devices or computing devices that guarantee portability and mobility. The terminal may be referred to as user equipment (UE), a station (STA), a mobile subscriber (MS), or the like.

The base station 700 may control and manage a cell (for example, a macrocell, a femtocell and/or a picocell) corresponding to a service area, and perform functions such as signal transmission, channel designation, channel monitoring, self-diagnosis, and/or relay. The base station may be referred to as a next generation NodeB (gNB) or an access point (AP).

The terminal 600 may include a frequency resource measuring apparatus 800.

The frequency resource measuring apparatus 800 may measure a frequency resource being used by the terminal 600 in a wireless communication system. For example, the frequency resource measuring apparatus 800 may measure the frequency resource being used by the terminal 600 using energy detection (ED).

Further, the frequency resource measuring apparatus 800 may increase the accuracy of measurement through ED, and may set an ED threshold for performing ED. The frequency resource measuring apparatus 800 may include a memory 900 and a processor 1000.

The memory 900 may store instructions (or programs) executable by the processor 1000. For example, the instructions include instructions to perform the operation of the processor 1000 and/or the operation of each element of the processor 1000.

The processor 1000 may process data stored in the memory 900. The processor 1000 may execute a computer-readable code (for example, software) stored in the memory 900 and instructions triggered by the processor 1000.

The processor 1000 may be a data processing device implemented by hardware including a circuit having a physical structure to perform desired operations. For example, the desired operations may include instructions or codes included in a program.

For example, the hardware-implemented data processing device may include a microprocessor, a central processing unit (CPU), a processor core, a multi-core processor, a multiprocessor, an application-specific integrated circuit (ASIC), and a field-programmable gate array (FPGA).

The processor 1000 may be implemented separately from the terminal 600, or may be implemented as an existing processor 610 included in the terminal 600. Further, the memory 900 may be implemented as an existing memory 630 included in the terminal 600.

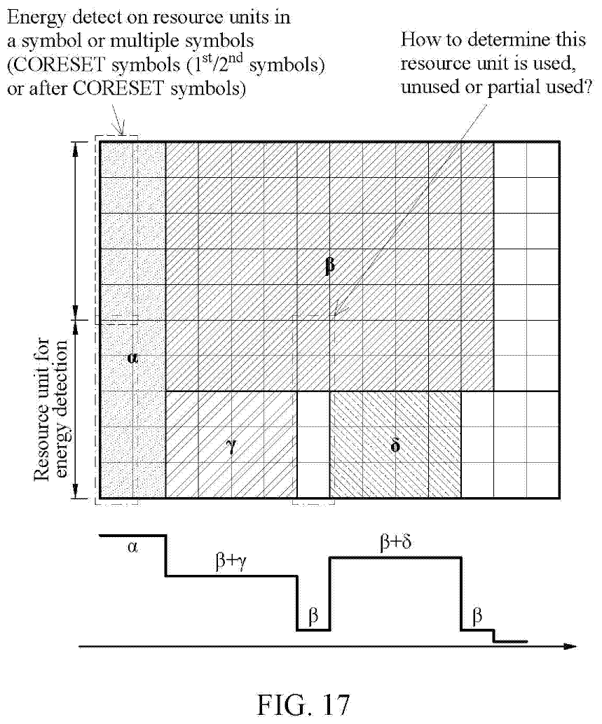

FIG. 17 is a diagram to describe a frequency resource measuring operation performed by a frequency resource measuring apparatus according to an example embodiment.

The frequency resource measuring apparatus 800 may measure a frequency resource being used by performing ED on a CORESET configured with one or more symbols and frequency resources on a channel bandwidth set for the terminal 600 by the base station 700 set in one carrier.

The frequency resource measuring apparatus 800 may perform ED on the CORESET configured with one or more symbols and frequency resources on the channel bandwidth set for the terminal 600 by the base station 700. The frequency resource measuring apparatus 800 may determine whether a resource block (RB) or resource block group (RBG) is used for data traffic transmitted in downlink on a channel bandwidth set for the terminal 600 by the base station 700 set in one carrier through ED.

In the case of self-carrier scheduling and the CORESET bandwidth set to all bands on one carrier, the frequency resource measuring apparatus 800 may set the ED threshold based on the reception power of a PDCCH distributed and transmitted on the frequency band.

The frequency resource measuring apparatus 800 may determine whether the RB and/or RBG is used by performing ED on the RB or RBG in a frequency domain for data traffic transmitted in downlink based on the ED threshold.

The frequency resource measuring apparatus 800 may improve the measurement performance for setting the ED threshold. For example, the frequency resource measuring apparatus 800 may accurately measure an element for setting the ED threshold.

The frequency resource measuring apparatus 800 may receive an SS/PBCH block transmitted from the base station 700 and set a power level received from the SS/PBCH block as the ED threshold.

The SS/PBCH block may include a primary synchronization signal (PSS), a secondary synchronization signal (SSS), a physical broadcast channel (PBCH), and a physical broadcast channel-demodulation reference signal (PBCH-DMRS).

The frequency resource measuring apparatus 800 may measure a reception power level for at least one of the PSS, the SSS, the PBCH, and the PBCH-DMRS. The frequency resource measuring apparatus 800 may determine a reference power for a channel bandwidth of a carrier to be measured, based on 20 resource blocks (20-RBs) occupied by the SS/PBCH block based on the reception power level. The frequency resource measuring apparatus 800 may determine the reference power through an average of received powers if the terminal 600 receives the same SS/PBCH block indices among SS/PBCH block indices transmitted from the base station 700 to determine an accurate reference power.

In addition, the frequency resource measuring apparatus 800 may determine the reference power through an average of received powers if the terminal 600 receives the same SS/PBCH block indices transmitted at different times among SS/PBCH block indices transmitted from the base station 700 periodically every 20 ms to determine the reference power.

The configuration of CORESET #0 for receiving a remaining minimum system information-physical downlink shared channel (RMSI-PDSCH) in the wireless communication system 20 may be obtained through PDCCH-Config-SIB1 8-bit information included in PBCH contents when the SS/PBCH is received (see Table 10).

TABLE 10

| PBCH contents | Size |
|---|---|
| systamFrameNumber | 10 bits (6 bits + 4 bits) |
| halfFrameIndex | 1 bit |
| ssb-indexExplicit | 0 bit for sub 6 GHz |
| SS block index indication | 3 bits for over 6 GHz |
| subCarrierSpacingCommon | |
| DL numerology to be used for RMSI | 1 bit |
| Subcarrier spacing for SIB1, Msg.2/4 for initial | (15 and 30 kHz for sub 6 GHz |
| access and SI-messages. | 60 and 120 kHz over 6 GHz) |
| ssb-subcarrierOffset | |
| The freq domain offset between SSB and the | 4 bits + 1 bit (for sub 6 GHz) |
| overall RB grid in number of subcarriers | |
| pdcchConfigSIB1 | |
| CORESET Configuration fot RMSI | 8 bits |
| (e.g. bandwidth, duration, start tinting and | |
| frequency position) | |
| dmrs-TypeA-Position | |
| Position of (first) DL DM-RS. Corresponds to L1_ | 1 bit |
| parameter ‘DL-DMRS-typeA-pos’ | |
| cellBarred | |
| Indicates whether the cell allows UEs to camp | 1 bit |
| on this cell | |
| intraFreqReselection | |
| indicates that intraFreqReselection is not | 1 bit |
| allowed when cellBarred is set to barred | |
| Spare | 1 bit |
| CRC | 24 bits |
| Total | 56 bit |

The PDCCH-Config-SIB1 information may include a bandwidth of CORESET #0, a duration, a starting timing, and frequency location information occupied by CORESET #0. Therefore, at the time/frequency location occupied by CORESET #0, the frequency resource measuring apparatus 800 may obtain RMSI-PDSCH allocation information through a corresponding Type-0 PDCCH and receive an RMSI-PDSCH by monitoring the Type-0 PDCCH scrambled and transmitted with the SI-RNTI allocated for transmitting system information.

If the time/frequency location occupied by CORESET #0 is an initial bandwidth part (BWP), the base station 700 may configure, for each terminal 600, up to 4 BWPs to be used to transmit the PDSCH in addition to the initial BWP. The base station 700 may set one of up to four BWPs as an active BWP.

If the base station 700 does not configure up to four BWPs other than the initial BWP, the initial BWP may be set as the active BWP. For example, the base station 700 may set the initial BWP as the active BWP to simplify the wireless communication system 20, such that the base station 700 may transmit the PDSCH to the terminal 600 through the active BWP. The terminal 600 may receive the PDSCH transmitted from the base station 700 in the active BWP.

The frequency resource measuring apparatus 800 may measure a power level based on the PDCCH that is scrambled and transmitted with the SI-RNTI.

When the base station 700 uses the initial BWP as the active BWP configured to the terminal 600, the frequency resource measuring apparatus 800 may receive the PDCCH distributed over the entire frequency domain of the initial BWP. At this time, the PDCCH may be scrambled and transmitted with the SI-RNTI transmitted in the initial BWP.

The frequency resource measuring apparatus 800 may measure the reception power level of the PDCCH and a fluctuation in power level on the frequency resources, that is, between the RBs or RBGs.

The frequency resource measuring apparatus 800 may receive the PDCCH distributed based on the reception reference power of the received SS/PBCH block, and measure the power level that may vary between the RBs by calculating a fluctuation in the measured reception power level.

The frequency resource measuring apparatus 800 may set an ED threshold value for each RB and/or for each RBG when performing ED based on the power level. The frequency resource measuring apparatus 800 may determine whether or not an RB and/or an RBG is being used based on the ED threshold, and measure usage information of frequencies used in one or more carriers.

The frequency resource measuring apparatus 800 may measure a power level based on a PDCCH DM-RS used for the PDCCH that is scrambled and transmitted with the SI-RNTI.

When the base station 700 uses the initial BWP as the active BWP configured to the terminal 600, the frequency resource measuring apparatus 800 may receive the PDCCH that is scrambled and transmitted with the SI-RNTI transmitted in the initial BWP and distributed over the entire frequency domain of the initial BWP, and a DM-RS of the PDCCH.

The frequency resource measuring apparatus 800 may measure the reception power level of the PDCCH and the DM-RS of the PDCCH and a fluctuation in power level between the frequency resources (for example, the RBs and/or RBGs).

The frequency resource measuring apparatus 800 may receive the PDCCH distributed based on the reception reference power of the received SS/PBCH block and the DM-RS of the PDCCH, and measure the power level that may vary between the RBs by calculating a fluctuation in the measured reception power level.

The frequency resource measuring apparatus 800 may set an ED threshold for each RB and/or RBG when performing ED based on the power level, and determine whether the corresponding RB and/or RBG is being used. The frequency resource measuring apparatus 800 may measure usage information of frequencies used in one or more carriers.

The frequency resource measuring apparatus 800 may measure the power level based on a wideband DM-RS transmitted in CORESET #0.

In the case of LTE, a signal is transmitted by being allocated to the entire channel bandwidth used in a cell-specific reference signal (CRS) system. In the case of an NR system, a CRS does not exist, and a UE-specific DM-RS is used as a reference signal used for demodulation of a PDCCH and a PDSCH during downlink transmission.

In the NR system, similar to the CRS of the LTE, there is no reference signal allocated to the entire bandwidth. Thus, the coverage of the PDCCH, the downlink control channel, transmitted in the NR system may deteriorate compared to the coverage of the PDCCH, the LTE downlink control channel.

Therefore, in the NR system, the terminal 600 may configure the wideband DM-RS to prevent the coverage of the PDCCH from deteriorating compared to that of LTE. The terminal 600 may receive the wideband DM-RS in a wider bandwidth transmitted from the base station 700 and use the wideband DM-RS to decode the PDCCH, thereby preventing the deterioration of the coverage of the PDCCH.

When the wideband DM-RS is configured to the terminal 600, the frequency resource measuring apparatus 800 may perform channel measurement and power level measurement through the wideband DM-RS. The frequency resource measuring apparatus 800 may measure the reception power level of the PDCCH and a fluctuation in power level on the frequency resources (for example, the RBs and/or RBGs) through channel measurement and power level measurement in the channel bandwidth in which the wideband DM-RS is configured.

The frequency resource measuring apparatus 800 may set an ED threshold for each RB and/or RBG when performing ED based on the reference power measured based on the SS/PBCH block.

The frequency resource measuring apparatus 800 may determine whether or not an RB and/or an RBG is being used based on the ED threshold for each RB and/or RBG, and measure usage information of frequencies used in one or more carriers.

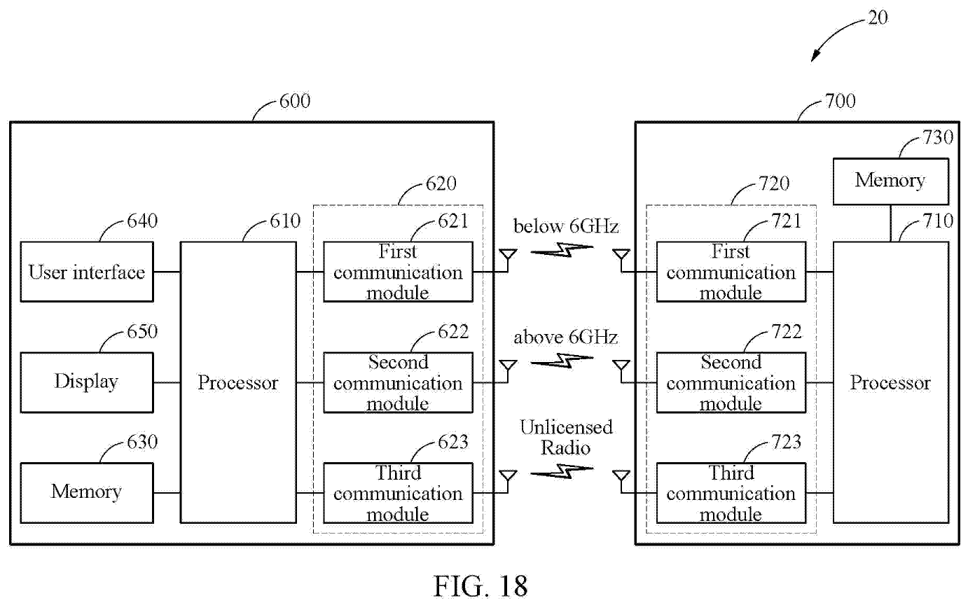

FIG. 18 is a block diagram illustrating the wireless communication system of FIG. 15.

The terminal 600 may include a processor 610, a communication module 620, a memory 630, a user interface 640, and a display 650.

The processor 610 and the memory 630 may be the processor 1000 and the memory 900 shown in FIG. 16, respectively. For example, the frequency resource measuring apparatus 800 may be implemented with the processor 610 and the memory 630.

The processor 610 may execute various instructions or programs and process data in the terminal 600. Further, the processor 610 may control the overall operation of the units of the terminal 600 and control data transmission and reception between the units. Here, the processor 610 may be configured to perform all functions of the terminal 600. For example, the processor 610 may receive slot configuration information, determine a slot configuration based on the received slot configuration information, and perform communication according to the determined slot configuration.

The communication module 620 may be an integrated module that performs wireless communication using a wireless communication network and wireless LAN connection using a wireless LAN. The communication module 620 may include a first communication module 621, a second communication module 622, and a third communication module 623.

For example, the first communication module 621 and the second communication module 622 may be cellular communication interface cards, and the third communication module 623 may be an unlicensed band communication interface card. That is, the communication module 620 may include a plurality of embedded or external network interface cards (NICs) including the cellular communication interface cards 621 and 622 and the unlicensed band communication interface card 623.

Although FIG. 18 illustrates the communication module 620 being an integrated module, the first to third communication modules 621 to 623 (for example, the network interface cards) may be independently disposed according to the circuit configuration or use.

The cellular communication interface card 621 may transmit and receive a radio signal to and from at least one of the base station 700, an external device, and a server using a mobile communication network, and provide a cellular communication service using a first frequency band based on an instruction from the processor 610.

The cellular communication interface card 621 may include at least one NIC module which uses a frequency band of less than 6 GHz. The at least one NIC module of the cellular communication interface card 621 may independently perform cellular communication with at least one of the base station 700, the external device, and the server according to a cellular communication standard or protocol of a frequency band of less than 6 GHz supported by the corresponding NIC module.

The cellular communication interface card 622 may transmit and receive a radio signal to and from at least one of the base station 700, an external device (not shown), and a server (not shown) using a mobile communication network, and provide a cellular communication service using a second frequency band based on an instruction from the processor 610.

The cellular communication interface card 622 may include at least one NIC module which uses a frequency band of 6 GHz or more. The at least one NIC module of the cellular communication interface card 622 may independently perform cellular communication with at least one of the base station 700, the external device, and the server according to a cellular communication standard or protocol of a frequency band of 6 GHz or more supported by the corresponding NIC module.

The unlicensed band communication interface card 623 may transmit and receive a radio signal to and from at least one of the base station 700, an external device, and a server using a third frequency band which is an unlicensed band, and provide a communication service of an unlicensed band based on an instruction from the processor 610.

The unlicensed band communication interface card 623 may include at least one NIC module which uses the unlicensed band. For example, the unlicensed band may be a band of 2.4 GHz or 5 GHz.

The at least one NIC module of the unlicensed band communication interface card 623 may independently or dependently perform radio communication with at least one of the base station 700, the external device, and the server according to an unlicensed band communication standard or protocol of a frequency band supported by the corresponding NIC module.

The memory 630 may store a control program used in the terminal 600 and various data relevant thereto. The control program may include a predetermined program required for the terminal 600 to perform radio communication with at least one of the base station 700, the external device, and the server.

The user interface 640 may include various types of input/output devices provided in the terminal 600. For example, the user interface 640 may receive a user input using various input devices, and the processor 610 may control the terminal 600 based on the received user input. In addition, the user interface 640 may perform an output based on the instruction from the processor 610 using various output devices.

The display 650 may display various images on a display screen. The display 650 may output various display objects such as content executed by the processor 610 or a user interface based on the control instruction from the processor 610.

The base station 700 may include a processor 710, a communication module 720, and a memory 730.

The processor 710 may execute various instructions or programs and process data in the base station 700. Further, the processor 710 may control the overall operation of the units of the base station 700 and control data transmission and reception between the units.

The processor 710 may be configured to perform functions of the base station 700. For example, the processor 710 may signal slot configuration information and perform communication according to the signaled slot configuration.

The communication module 720 may be an integrated module that performs wireless communication using a wireless communication network and wireless LAN connection using a wireless LAN. The communication module 720 may include a first communication module 721, a second communication module 722, and a third communication module 723.

For example, the first communication module 721 and the second communication module 722 may be cellular communication interface cards, and the third communication module 723 may be an unlicensed band communication interface card. That is, the communication module 720 may include a plurality of embedded or external network interface cards including the cellular communication interface cards 721 and 722 and the unlicensed band communication interface card 723.

Although FIG. 18 illustrates the communication module 720 being an integrated module, the first to third communication modules 721 to 723 (for example, the network interface cards) may be independently disposed according to the circuit configuration or use.

The cellular communication interface card 721 may transmit and receive a radio signal to and from at least one of the terminal 600, an external device (not shown), and a server (not shown) using a mobile communication network, and provide a cellular communication service using a first frequency band based on an instruction from the processor 710.

The cellular communication interface card 721 may include at least one NIC module which uses a frequency band of less than 6 GHz. The at least one NIC module of the cellular communication interface card 721 may independently perform cellular communication with at least one of the terminal 600, the external device, and the server according to a cellular communication standard or protocol of a frequency band of less than 6 GHz supported by the corresponding NIC module.

The cellular communication interface card 722 may transmit and receive a radio signal to and from at least one of the terminal 600, an external device (not shown), and a server (not shown) using a mobile communication network, and provide a cellular communication service using a second frequency band based on an instruction from the processor 710.

The cellular communication interface card 722 may include at least one NIC module which uses a frequency band of 6 GHz or more. The at least one NIC module of the cellular communication interface card 722 may independently perform cellular communication with at least one of the terminal 600, the external device, and the server according to a cellular communication standard or protocol of a frequency band of 6 GHz or more supported by the corresponding NIC module.

The unlicensed band communication interface card 723 may transmit and receive a radio signal to and from at least one of the terminal 600, an external device (not shown), and a server (not shown) using a third frequency band which is an unlicensed band, and provide a communication service of an unlicensed band based on an instruction from the processor 710.

The unlicensed band communication interface card 723 may include at least one NIC module which uses the unlicensed band. For example, the unlicensed band may be a band of 2.4 GHz or 5 GHz.

The at least one NIC module of the unlicensed band communication interface card 723 may independently or dependently perform radio communication with at least one of the terminal 600, the external device, and the server according to an unlicensed band communication standard or protocol of a frequency band supported by the corresponding NIC module.

FIG. 18 is a block diagram illustrating an example of the terminal 600 and the base station 700, wherein the blocks are illustrated separately to logically distinguish the elements of the device. Accordingly, the elements of the device described above may be mounted as one chip or as a plurality of chips depending on the design of the device. In addition, some elements of the terminal 600, for example, the user interface 640 and the display 650, may be selectively provided in the terminal 600. In addition, the user interface 640 and the display 650 may be additionally provided in the base station 700, as necessary.

The components described in the example embodiments may be implemented by hardware components including, for example, at least one digital signal processor (DSP), a processor, a controller, an application-specific integrated circuit (ASIC), a programmable logic element, such as a field-programmable gate array (FPGA), other electronic devices, or combinations thereof. At least some of the functions or the processes described in the example embodiments may be implemented by software, and the software may be recorded on a recording medium. The components, the functions, and the processes described in the example embodiments may be implemented by a combination of hardware and software.

The methods according to the above-described example embodiments may be recorded in non-transitory computer-readable media including program instructions to implement various operations of the above-described example embodiments. The media may also include, alone or in combination with the program instructions, data files, data structures, and the like. The program instructions recorded on the media may be those specially designed and constructed for the purposes of example embodiments, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher-level code that may be executed by the computer using an interpreter. The above-described devices may be configured to act as one or more software modules in order to perform the operations of the above-described example embodiments, or vice versa.

The software may include a computer program, a piece of code, an instruction, or some combination thereof, to independently or uniformly instruct or configure the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network-coupled computer systems so that the software is stored and executed in a distributed fashion. The software and data may be stored by one or more non-transitory computer-readable recording mediums.

A number of example embodiments have been described above. Nevertheless, it should be understood that various modifications may be made to these example embodiments. For example, suitable results may be achieved if the described techniques are performed in a different order and/or if components in a described system, architecture, device, or circuit are combined in a different manner and/or replaced or supplemented by other components or their equivalents.

Accordingly, other implementations are within the scope of the following claims.

What is claimed is:

1. A resource usage measuring method comprising:
measuring a resource usage in a frequency domain based on a demodulation reference signal (DM-RS) transmitted from a base station; and
measuring a resource usage in a time domain based on the DM-RS.

2. The resource usage measuring method of claim 1, wherein the measuring of the resource usage in the frequency domain comprises:
detecting the number of resource blocks included in a resource block group allocated to physical downlink shared channel (PDSCH) scheduling; and
verifying whether the DM-RS is transmitted in a symbol in which the DM-RS is likely to be transmitted in the unit of the resource block group.

3. The resource usage measuring method of claim 2, wherein the detecting comprises:
determining a configuration of a bandwidth part (BWP) used by the base station; and
detecting the number of resource blocks included in the resource block group based on the configuration of the BWP.

4. The resource usage measuring method of claim 2, wherein the verifying comprises verifying whether the DM-RS is transmitted based on a correlation in the unit of the resource blocks.

5. The resource usage measuring method of claim 1, wherein the measuring of the resource usage in the frequency domain comprises detecting an index of a first resource block allocated to the PDSCH scheduling and the number of consecutive resource blocks.

6. The resource usage measuring method of claim 1, wherein the measuring of the resource usage in the time domain comprises:
detecting a DM-RS in a symbol;
determining PDSCH scheduling allocation combinations based on an index of the symbol in which the DM-RS is detected; and
determining a combination of symbols in which the DM-RS of the PDSCH is located among the combinations.

7. The resource usage measuring method of claim 6, wherein the detecting comprises monitoring symbols in which the DM-RS of the PDSCH is likely to be located.

8. The resource usage measuring method of claim 6, wherein the determining comprises determining the combination based on a reception power of the symbols.

9. The resource usage measuring method of claim 6, wherein the determining comprises determining the combination based on a constellation of a signal transmitted in the symbols.

10. A resource usage measuring apparatus comprising:
a memory configured to store instructions; and
a processor configured to execute the instructions,
wherein when the instructions are executed by the processor, the processor is configured to:
measure a resource usage in a frequency domain based on a demodulation reference signal (DM-RS) transmitted from a base station, and measure a resource usage in a time domain based on the DM-RS.

11. The resource usage measuring apparatus of claim 10, wherein the processor is configured to detect the number of resource blocks included in a resource block group allocated to physical downlink shared channel (PDSCH) scheduling, and verify whether the DM-RS is transmitted in a symbol in which the DM-RS is likely to be transmitted in the unit of the resource block group.

12. The resource usage measuring apparatus of claim 11, wherein the processor is configured to determine a configuration of a bandwidth part (BWP) used by the base station, and detect the number of resource blocks included in the resource block group based on the configuration of the BWP.

13. The resource usage measuring apparatus of claim 11, wherein the processor is configured to verify whether the DM-RS is transmitted based on a correlation in the unit of the resource blocks.

14. The resource usage measuring apparatus of claim 10, wherein the processor is configured to detect an index of a first resource block allocated to the PDSCH scheduling and the number of consecutive resource blocks.

15. The resource usage measuring apparatus of claim 10, wherein the processor is configured to detect a DM-RS in a symbol, determine PDSCH scheduling allocation combinations based on an index of the symbol in which the DM-RS is detected, and determine a combination of symbols in which the DM-RS of the PDSCH is located among the combinations.

16. The resource usage measuring apparatus of claim 15, wherein the processor is configured to monitor symbols in which the DM-RS of the PDSCH is likely to be located.

17. The resource usage measuring apparatus of claim 15, wherein the processor is configured to determine the combination based on a reception power of the symbols.

18. The resource usage measuring apparatus of claim 15, wherein the processor is configured to determine the combination based on a constellation of a signal transmitted in the symbols.
